(19) United States
(12) Patent Application Publication
(10) Pub. No.: US 2025/0240216 A1
(43) Pub. Date: Jul. 24, 2025

(54) METHODS, ARCHITECTURES, APPARATUSES AND SYSTEMS FOR ENHANCEMENTS TO UNIFY NETWORK DATA ANALYTICS SERVICES

(71) Applicants: Morteza Kheirkhah, London (GB); Ulises Olvera-Hernandez, Saint-Lazare (CA); Tezcan Cogalan, London (GB); Mona Ghassemian, Kent (GB)

(72) Inventors: Morteza Kheirkhah, London (GB); Ulises Olvera-Hernandez, Saint-Lazare (CA); Tezcan Cogalan, London (GB); Mona Ghassemian, Kent (GB)

(21) Appl. No.: 18/699,479

(22) PCT Filed: Oct. 10, 2022
(86) PCT No.: PCT/US2022/046150

§ 371 Date: Apr. 8, 2024

Related U.S. Application Data
(60) Provisional application No. 63/253,685, filed on Oct. 8, 2021.

(51) Int. Cl. H04L 41/14; H04L 43/04

(52) U.S. Cl. CPC H04L 41/14; H04L 43/04

(57) ABSTRACT

Procedures, methods, architectures, apparatuses, systems, devices, and computer program products to facilitate coordination between multiple radio access technologies (RATs). In certain embodiments, a Stack Data Analytics Coordinator (SDAC) may be provided in association with radio protocol stacks (e.g., 5G NR and/or Wi-Fi) at user equipment and/or network access points (e.g., gNB and/or Wi-Fi AP). The SDAC may coordinate requests and/or collection of information (e.g., protocol stack measurements and/or statistics) among entities of multiple RATs. In certain embodiments, Network Data Analytics Services may be enhanced by being extended beyond a core network, such as to user equipment and/or network access points.

### CROSS-REFERENCE TO RELATED APPLICATIONS

This application claims the benefit of U.S. Provisional Patent Application No. 63/253,685 filed 8 Oct. 2021, which is incorporated herein by reference.

### TECHNICAL FIELD

The present disclosure is generally directed to the fields of communications, software and encoding, including, for example, to methods, architectures, apparatuses, systems directed to enhancements to network data analytics services. More particularly, the present disclosure includes methods, architectures, apparatuses, systems directed to enhancements to unify network data analytics services for communications systems, such as 3GPP systems.

### BACKGROUND

Since 2010 consistent exponential growth for mobile data traffic has been observed. Globally, mobile traffic has increased roughly 58 times between 2012 and 2020. Forecasting estimates that another 4.5 times growth of global mobile data traffic is projected for the period between 2020 and 2026 when 5G networks are rolling out. The growth rate may be assumed to be driven by the increasing number of mobile users, the emergence of new applications due to growing artificial intelligent technologies and also new capabilities of the latest wireless technologies (e.g., higher bandwidth and lower latency), as well as the impact that the Internet of Things is predicted to bring to mobile networks.

To cope with the high traffic demand, 5G networks approach the capacity scarceness issue by utilizing unlicensed ultra-high frequency bands (e.g., above 24 GHz), and mmWave technology.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an architecture diagram illustrating an example deployment scenario for integrating WLAN with 5G NR;

FIG. 3 is an architecture diagram illustrating an example deployment scenario for a WTRU which does not support 5G NR and may authenticate to a 5G Core via non-3GPP access;

FIG. 4 is an architecture diagram illustrating an example deployment scenario for an ATSSS framework for integrating 5G NR with non-3GPP access;

FIG. 5 is an architecture diagram illustrating an example deployment scenario showing the interactions of various Stack Data Analytics Coordinators (SDACs) with protocol stacks;

FIG. 6 is an architecture diagram illustrating an example deployment scenario showing a disaggregated 5G NR protocol stack;

FIG. 7 is an architecture diagram illustrating an example deployment scenario showing interactions between SDACs, a Network Data Analytics Function (NWDAF), an Analytics Data Repository Function (ADRF) and a base station;

FIG. 8A is a first portion of a procedural diagram illustrating an example of a communications flow which includes interactions between a Medium Access Control (MAC) layer, SDAC, NWDAF, and an ADRF;

FIG. 8B is a second portion of the procedural diagram illustrating the example of the communications flow continuing from FIG. 8A;

FIG. 9 is an architecture diagram illustrating an example deployment scenario where a Messaging Framework may be utilized;

FIG. 10 is a procedural diagram illustrating an example of a communications flow which includes interactions between a SDAC and a NWDAF via a Messaging Framework;

FIG. 11 is an architecture diagram illustrating an example deployment scenario where an ATSSS framework may be used to steer WTRU traffic;

FIG. 12 is an architecture diagram illustrating an example deployment scenario where an application at a WTRU may collect network related measurements and/or analytics information;

FIG. 13 is a procedural diagram illustrating an example for coordinating provisioning of information between protocol layers;

FIG. 14 is a procedural diagram illustrating an example for coordinating provisioning of information between protocol layers of different protocol stacks;

FIG. 15 is a procedural diagram illustrating an example for coordinating provisioning of information between protocol layers at different locations;

FIG. 16 is a procedural diagram illustrating another example for coordinating provisioning of information between protocol layers;

FIG. 17 is a procedural diagram illustrating an example for coordinating provisioning of information between protocol layers at different locations;

FIG. 18 is a procedural diagram illustrating another example for coordinating provisioning of information between protocol layers;

FIG. 19 is a procedural diagram illustrating an example for coordination provisioning of information between an application and protocol layers; and

FIG. 20 is a procedural diagram illustrating an example for coordination provisioning of information between an application and protocol layers.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

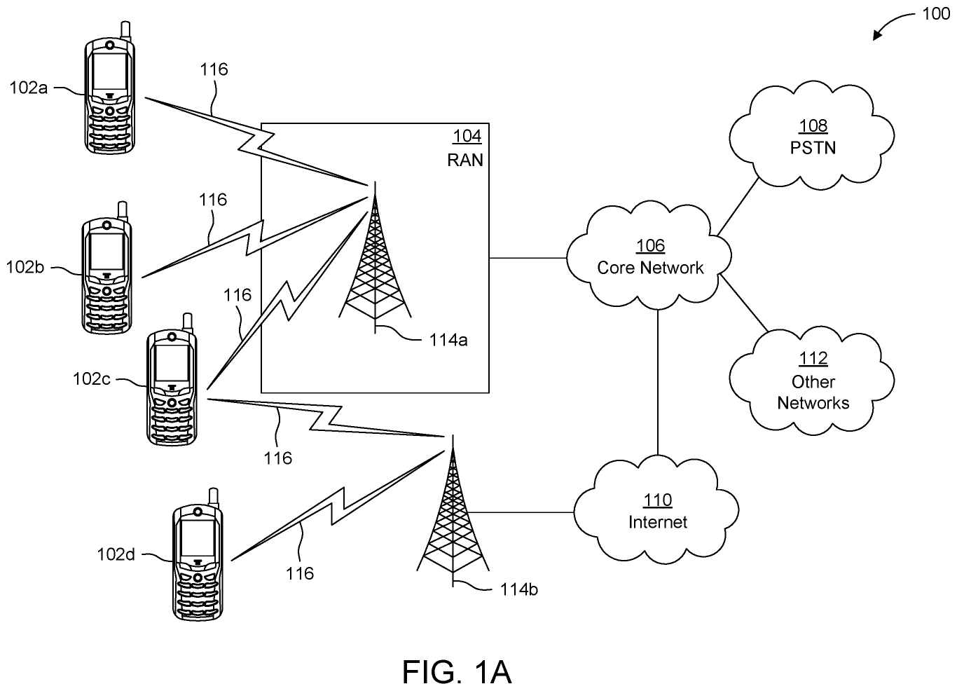

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following acronyms may used throughout the description:
AMF Access and Mobility Management Function
ADRF Analytics Data Repository Function
AnLF Analytics Logical Function
ANDSP Access Network Discovery and Selection Policy
ATSSS Access Traffic steering, switching, and splitting
ATSSS-HL Access Traffic steering, switching, and splitting High-Level
ATSSS-LL Access Traffic steering, switching, and splitting Low-Level
AUSF Access and Mobility Management Function
DCCF Data Collection Coordination Function
O-RAN Open RAN (Open Radio Access Network)
MAC Media Access Control
MA-PDU Multi-Access PDU Session
MFAF Messaging Framework Adaptor Function
MTLF Model Training Logical Function
MPTCP Multi-Path TCP
N3IWF Non-3GPP Interworking Function
N5CW Non-5G-Capable over WLAN
NAS Network Access Stratum
NF Network Function
NWDAF Network Data Analytics Function
OAM Operations, Administration and Maintenance
PCF Policy Control Function
PMF Performance Measurement Function
PDU Packet Data Unit
RAN Radio Access Network
RFSP RAT Frequency Selection Priority
RRC Radio Resource Control
RLC Radio Link Control
SMF Session Management Function
TNGF Trusted Non-3GPP Gateway Function
TNAP Trusted Non-3GPP Access Point
UE User Equipment
URSP UE Route Selection Policy
UPF User Plane Function
WLAN Wireless LAN
WLANSP WLAN Selection Policy

With 5G NR and its successor 6G are expected and/or envisioned to unlock a wide array of opportunities and new use cases that may provide significant positive impact(s) on the global economy. Wide-scale deployment of 5G networks is predicted by some to generate 13.6 trillion dollars in economic output and create 22.3 million new jobs by 2035 in the global 5G value chain alone. To potentially realize such gains and support a diverse set of future use cases (e.g., extreme low latency, coverage, high bandwidth, and/or high reliability), 5G and beyond networks (e.g., 6G and later) may need to support multi-connectivity paradigms which reinforces the potential need to coordinate with and utilise, other wide-spread wireless technologies, such as Wi-Fi, for example.

Since 2010 consistent (e.g., exponential) growth for mobile data traffic has been perceived. Global mobile traffic has been estimated to have increased 58× times between 2012 (e.g., when the wide deployment of 4G started) and 2020. Forecasting reports estimate another 4.5× times growth of global mobile data traffic for the period between 2020 and 2026 when 5G networks are rolled out. Such a potentially explosive growth rate may be driven by the increasing number of mobile users, the emergence of new applications due to growing artificial intelligent technologies and/or new capabilities of the latest wireless technologies (e.g., providing a higher bandwidth and/or lower latency), as well as the massive impact that the Internet of Things (Iot) is predicted to bring on mobile networks.

To cope with high traffic demand, 5G approaches the scarce capacity problem by relying on the unlicensed ultra-high frequency bands (e.g., above 24 GHz), and mmWave technology. It is seen as a promising approach for 5G and/or 6G rate-hungry services. However, the promised high performance of multi-gigabit per-second data rates may be highly intermittent and/or unstable due to sensitivity of mmWave signals to the environment which is an inherent problem with all wireless technologies operating at higher frequency bands. Thus, a mobile operator's 5G and beyond (e.g., 56, 6G and/or beyond) deployment strategy may be, for example, to couple the mmWave radios with sub-6 GHz radios in a multi-connectivity fashion to complement each other with an aim of providing the required high reliability and high data rates for 5G and/or 6G-enabled use cases. The multi-connectivity paradigm may be expected to be a natural trend in 5G and beyond wireless networks motivated by the need to accommodate the growing traffic demand, and leverage the advantage of other lower cost, vast spread technologies and their successors (e.g., Wi-Fi 5, 6, 6E, 7 and so forth).

Like cellular technology, Wi-Fi technology is also evolving. Wi-Fi 6 is expected to go mainstream in 2021 and Wi-Fi 7 is planned to be standardised by 2024. It has been estimated that there may be nearly 628 million public Wi-Fi hotspots globally by 2023, which is up from 169 million hotspots in 2018. Around 11% of these devices may be Wi-Fi 6 which supports up to 10 Gbps data rates (e.g., 5× faster than the prior generation). A close technological similarity between the latest releases of Wi-Fi and 5G-NR combined with the emerging OpenRoaming concept, which lets mobile devices roam between Wi-Fi networks seamlessly, makes Wi-Fi networks an attractive platform to support 5G/6G-enabled use cases, such as those related to mobile (IoT) devices. WLAN and 5G Systems Interworking

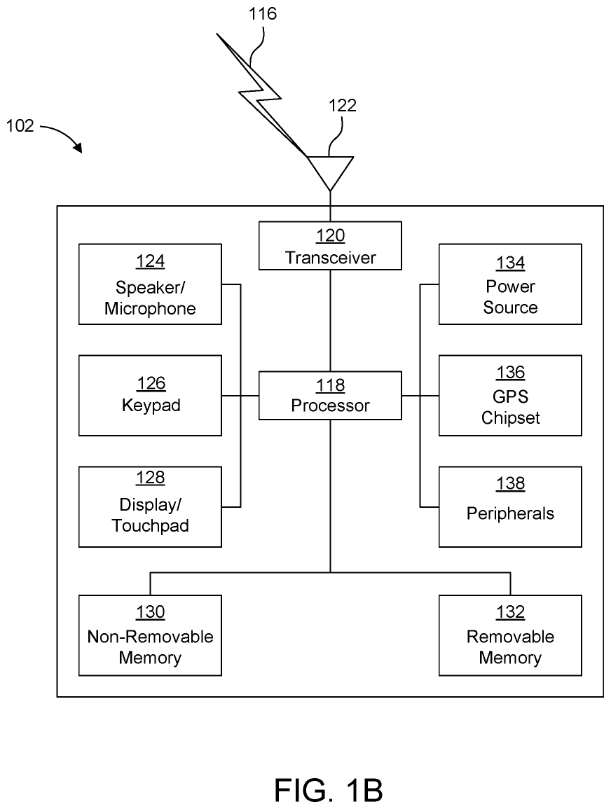

In 3GPP 5G Systems (e.g., Release 16 onwards-TS 25.501), WLAN, a non-3GPP access technology, may be integrated to a 5G core network as either a trusted or untrusted access technology. FIG. 2 is an architecture diagram illustrating an example deployment scenario for integrating WLAN with 5G NR. A N3IWF and/or TNGF gateway 202 is shown to support non-trusted and trusted access networks, respectively. Those skilled in the art should understand that certain components of the 5G core network are included and others are omitted in FIG. 2.

For untrusted access, a N3IWF (Non-3GPP Interworking Function) gateway 202 may be used. For trusted non-3GPP access, a TNGF (Trusted Non-3GPP Gateway Function) gateway 202 may be used. The NAS (Non-Access-Stratum) messages between a WTRU 102 and the 5G core 115 (e.g., an AMF 182) is transported over an NI interface either over 3GPP or non-3GPP access. NAS signalling and user plane data may be carried over non-3GPP access (e.g., only) via IPsec tunnels regardless of whether the access is trusted or not. A PCF 206 may manage user plane resources. An AUSF 208 may support 5G NR authentication.

In the case of the N3IWF 202, WLAN authentication at the MAC layer may be independent of the WTRU 5G core authentication given that WLAN access may not be trusted by the 5G core vendor. A Y2 interface may also be used to connect the N3WIF 202 to WLAN access over generic IP transport. Ipsec tunnels over the Nwu interface may handle both encryption and integrity protection for NAS signalling and user plane traffic.

With a trusted access scenario, the Ta interface may handle communication between a WLAN AP (e.g., Wi-Fi AP 204, otherwise referred to herein as a WLAN 204) and the TNGF 202. NAS messages and user data may be transported via the NWt interface over Ipsec tunnels. A difference between NWt and Nwu interfaces is that NWt applies no encryption so that data traffic can be securely encrypted only once by the WLAN MAC layer encryption mechanism between the WTRU 102 and WLAN AP (e.g., Wi-Fi AP 204). Across both deployment scenarios multiple Ipsec tunnels may be used for transporting both control plane (CP) and user plane (UP) traffic.

### Non-Capable Over WLAN (N5CW) Devices

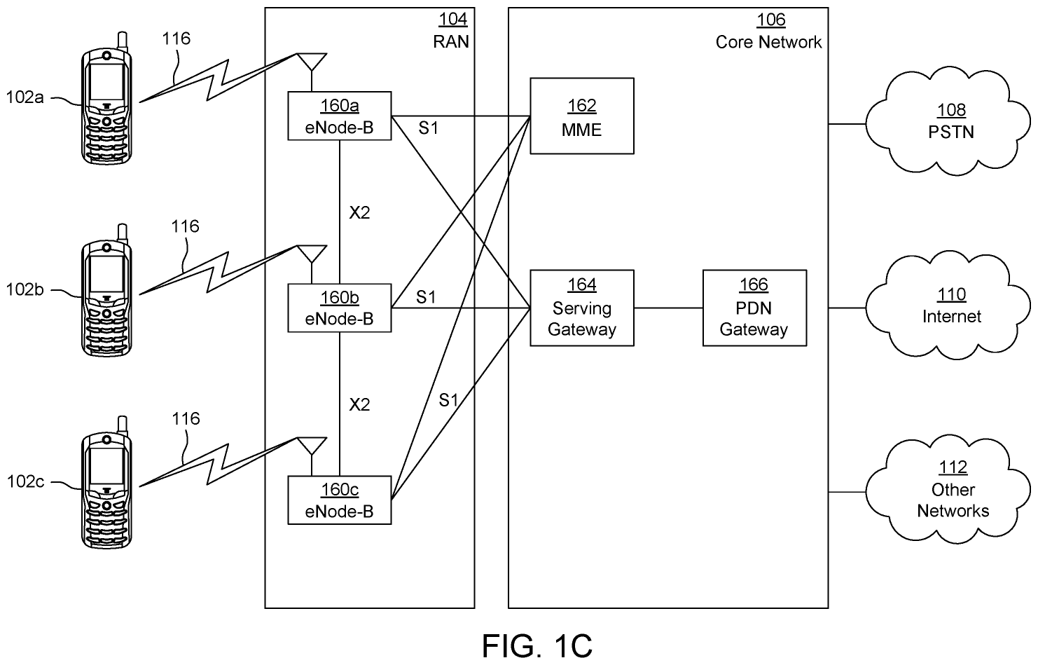

Another deployment scenario which has been considered by 3GPP is related to WTRUs 102 which do not support NAS signalling but have USIM so that they can authenticate to the 5G core. FIG. 3 is an architecture diagram illustrating an example deployment scenario for a WTRU which does not support 5G NR and may authenticate to a 5G Core via non-3GPP access. In FIG. 3, a WTRU 102 may connect to the 5G core via trusted WLAN access via a TWIF gateway function 302.

In FIG. 3, the TWIF 302 may carry NAS signalling for PDU session establishment on behalf of a WTRU 102 (e.g., a N5CW device 304) over a N1 interface. There may be no interfaces similar to the Nwu or NWt interfaces in this deployment scenario. Messages (e.g., all messages) may be carried directly over Wi-Fi (Yt′) and Yw interfaces with a TNAP (Trusted Non-3GPP Access Point) (e.g., Wi-Fi AP 204) in the middle which may act as a relay by passing all authentication credential messages to the TWIF 302. Technical details of such procedures are discussed in 3GPP TS 33.501.

### 3GPP Approaches for Selecting Non-3GPP Access and Routing Application Traffic

A 3GPP system may utilize an ANDSP (Access Network Discovery and Selection Policy) component to control and/or guide the behaviour of a WTRU when attempting to connect to a non-3GPP access network, such as in 3GPP TS 23.503, (e.g., only) when its user preference is not available and/or a desired WLAN AP is not accessible to connect to. In other words, the ANDSP helps a WTRU 102 to decide on selecting a trusted or non-trusted WLAN access according to a 3GPP access provider's policy and/or a WTRU's policy. The ANDSP has inherited the WLANSP (WLAN Selection Policy) from prior 3GPP standards to select untrusted non-3GPP access networks.

To route traffic of different applications, a WTRU 102 may use a URSP (UE Route Selection Policy) component to decide how to route application traffic across available access technologies. For example, an application flow may be routed over cellular access while another application flow may prefer to be routed over Wi-Fi access. To use all available access technologies simultaneously, a 3GPP system proposes a ATSSS (Access Traffic Steering, Switching and Splitting) framework to govern traffic distribution across various access technologies for both upstream and downstream traffic flows. The ATSSS utilizes a Multi-Access PDU session (MA-PDU), which allows a single PDU session to be established between a WTRU 102 and a 5G core 115 for (e.g., all) available accesses. This way the ATSSS can split an application's data packets on all available access technologies at the same time and/or without adding extra delay.

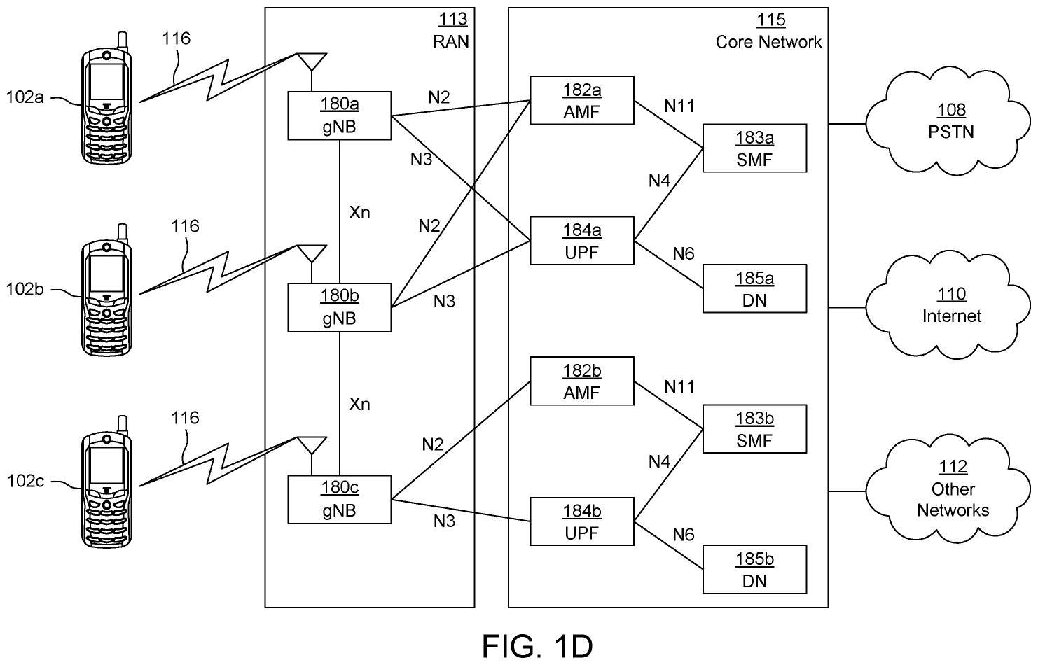

FIG. 4 is an architecture diagram illustrating an example deployment scenario for an ATSSS framework for integrating 5G NR with non-3GPP access, such as Wi-Fi. For example, an ATSSS-HL function mode for ATSSS-HL functions 404-a, 404-b uses Multi-Path TCP (MPTCP) and may (e.g., only) carry TCP/MPTCP traffic. An ATSSS-LL function mode for ATSSS-LL functions 406-a, 406-b may carry UDP, TCP, or Ethernet traffic. The latter steering functionality mode is currently proposed to operate on a per flow basis only so the ATSSS-HL mode may only split traffic on a per packet basis because MPTCP has mechanisms to handle out-of-order packets. A PMF (Performance Measurement Function) 408-a, 408-b is another component which may also be used for collecting some basic status and/or measurement information from a WTRU 102 such as RTT measurements and a status of access links (e.g., whether they are available or not). The PMF traffic may be carried by UDP over user plane interfaces between the WTRU 102 and the UPF 184.

### Overview

With 5G and/or 6G systems envisioned to unlock a wide array of new use cases in different areas (e.g., health, education, agriculture, industry). These use cases may typically require low-latency, high data rate and/or reliable communication (e.g., simultaneously). To efficiently handle such diverse traffic requirements (e.g., simultaneously), it may be important to utilize all available network paths between two endpoints of a connection. Following such a principle may naturally facilitate traffic engineering and in turn help applications meet their requirements.

Utilizing multiple access technologies simultaneously may provide path diversity at a network edge which may be especially beneficial for mobile users that typically rely on unstable wireless links at the last mile hop. However, realizing a multi-access framework comes with several challenges. For example, the current 3GPP standards allow the CN 115 to steer the WTRU's traffic at a UPF 184 between multiple access technologies (e.g., in the case of MA-PDU), but this operation may only be performed efficiently when the CN 115 has access to the fine-grained statistics and measurements across (e.g., all) access technologies as well as the WTRU. To steer traffic of one WTRU, the CN may also need information from all the other WTRUs connected to a same cell tower and/or Wi-Fi AP. Other information that the CN may need could be related to the WTRU's mobility predictions, traffic type, traffic load predictions, available resources at an eNB and/or gNB and/or Wi-Fi AP, and/or the history of packet retransmissions at the MAC layer and/or RLC (e.g., an RLC connection is activated at a base station). Once these statistics and measurements are available, the CN may efficiently employ intelligent algorithms (e.g., AI/ML techniques) for handling various network operations (e.g., steering traffic, data scheduling and managing inter-RAT packet retransmissions/duplications, and cell selection/handover).

To intelligently coordinate across different and/or heterogeneous access technologies, whether through CN, RAN or elsewhere, it may be important to be able to monitor and collect parameters from the radio protocol stack dynamically and flexibly with a low overhead (e.g., number of retransmissions at MAC and/or RLC layers, RLC head-of-line delay and so on). However, the state-of-the-art 3GPP multi-access frameworks (e.g., ATSSS which splits WTRU's traffic at the UPF or the dual connectivity and LTE WLAN Aggregation (LWA) frameworks where the WTRU's traffic is split at the PDCP layer) lack such functionalities. For 3GPP Release 18, a few study items have been planned to discuss ways in which (e.g., only) some basic RAN measurements, such as RSRP (reference signal received power) and/or RSRQ (reference signal received quality) from the PHY layer, may be used for the ATSSS framework, for example. However, collecting statics and measurements from other layers of the radio protocol stack have not yet been planned to be discussed.

A set of correlated problems within 3GPP systems may be magnified when a multi-access framework is used. The implication is that these problems may also exist in use-cases other than multi-access connectivity.

For example, there may be a data collection and/or storage problem may arise. In current 3GPP standards for both LTE and 5G-NR, the RRC layer (e.g., layer 3) has access to (e.g., all) lower layers, measurements may be collected and some parameters in those layers may be simultaneously controlled by sending RRC messages. However, it is not yet standardized how these measurements that are collected by the RLC layer can be exposed to various AI/ML engines running at a WTRU, RAN and/or CN in an efficient way (e.g., fast and with low overhead) that is needed for those engines to operate.

Although the RRC layer may currently collect a set of limited measurements across layers of the protocol stack, such collection may generate excessive control messages in the stack because a RRC message should pass from one layer to another until it reaches a destination layer (e.g., if the destination layer is at the PHY layer the RRC message should pass through PDCP, RLC and MAC layers before it reaches the PHY layer). In certain representative embodiments, there may be direct access to each layer of the protocol stack to collect data (e.g., statistics, measurements) and/or to provide analytics.

In certain representative embodiments, an analytics providing component (e.g., AI and/or ML engine) may express (e.g., provide, configure, indicate) its own desired data collection interval mainly because a desired data collection interval may not be the same between different AI and/or ML algorithms (or other inference mechanisms). For example, a coordinator component may closely interact with data providers and/or analytics providers requiring to use (e.g., consume) provided data. This coordination can reduce the amount of signaling required between analytics providers and/or consumers and data providers and/or consumers while satisfying their requirements.

For example, an analytics consumer and/or a data provider may be a layer at the protocol stack or an entity running outside the protocol stack. For a WTRU, an analytics consumer and/or a data provider may be an application. An analytics provider may run (e.g., perform) AI and/or ML algorithms or any other inference procedures. A data provider may provide statistics, measurements, and/or monitoring information.

For example, there may be an AI and/or ML deployment problem may arise. A unified approach to employ AI and/or ML techniques within the WTRU 102, RAN 104/113, WLAN 204, and/or Core Network (CN) 106/115 may be lacking. Currently, 3GPP standards may (e.g., only) support a Network and Data Analytics Function (NWDAF) within a CN 115 which can access other network functions (NFs) within the CN 115. A similar approach for the WTRU 102, RAN 104/113 and WLAN 204 is yet to be discussed and standardized. For example, there is no standard way AI and/or ML techniques to be used for operations within a particular layer of the protocol stack and/or to let applications running at a WTRU 102 to access network related analytics and measurements collected from the WTRU 102, RAN 104/113, WLAN 204, and/or CN 115. In this regard, it may be important for any analytics provider mechanisms (e.g., AI and/or ML engines and/or other inference mechanisms) to access statistics and measurements from the protocol stack as well as elsewhere outside the protocol stack (e.g., applications or other components), as this may be the (e.g., only) way these analytics providers can have a good modelling of the network state (e.g., environment) and in turn can produce accurate results and/or inferences (e.g., actions) not only for assisting network operations but also application operations.

In certain representative embodiments, a meddler component, which may also be referred to as a “Stack Data Analytics Coordinator” (SDAC) component, may be provided with each radio protocol stack (e.g., 5G-NR and/or Wi-Fi) at both user equipment (e.g., a WTRU 102 or other terminal device) and access network nodes (e.g., gNB 180 and/or Wi-Fi AP/Controller 204).

In certain representative embodiments, a Network Data Analytics Services concept, as currently standardized in the CN 115, may be extended into WTRU 102, RAN 104/113, and/or WLAN environments.

Such embodiments as described herein may address the foregoing problems in multi-access connectivity scenarios and/or other use cases.

### Stack Data Analytics Coordinator (SDAC)

In certain representative embodiments, an SDAC may perform coordination between data providers which may be in a protocol stack or elsewhere and analytics providers which may be anywhere in a 5GS and/or a WTRU 102. As an example, an analytics consumer may be located within the protocol stack (e.g., at the MAC layer) and the SDAC may provide an analytics provider to be operating close to the protocol stack (e.g., at a same box and/or device), minimizing the end-to-end communication latency between the consumer and provider components. Furthermore, one or more SDACs may coordinate between any of a WTRU 102, WLAN 204, RAN 104/113 and/or CN 106/115 such that the WTRU 102, WLAN 204, RAN 104/113 and/or CN 106/115 may (e.g., directly) interact with each other and exchange statistics, measurements and/or analytics in a flexible manner (e.g., fast and with low overhead). Hence, the AI and/or ML deployments within WTRU 102, WLAN 204, RAN 104/113 and/or CN 106/115 may be facilitated. These interactions by SDACs, operating at different domains (e.g., WTRU 102, WLAN 204, RAN 104/113 and/or CN 106/115), may also facilitate the deployment of federated (e.g., vertical) learning methods. In certain representative embodiments, the SDACs may exchange data and/or analytics information between themselves (e.g., other SDACs) and/or may exchange neural network models between themselves (e.g., other SDACs). For example, exchanging neural network models instead of raw data may significantly improve the privacy of data owners.

### Network Data Analytics Services Within WTRU, RAN and/or WLAN

Network Data Analytics Services are currently standardized only for the CN 115. In certain representative embodiments, Network Data Analytics Services may be extended to any of a RAN 104/113, WTRU 102, and/or WLAN 204 environments. For example, expanding Network Data Analytics Services may facilitate the deployment of AI and/or ML techniques and/or may also facilitate the manner in which data and/or analytics are stored and/or retrieved within any of a WTRU 102, WLAN 204, RAN 104/113 and/or CN 106/115. In some embodiments, an SDAC may reside at a RAN 104/113 (e.g., close to a gNB 180) and may interact with one or more Network Data Analytics Functions (NWDAFs) operating in any of the WTRU 102, WLAN 204, RAN 104/113 and/or CN 106/115.

In certain representative embodiments, a NWDAF instance in any of a WTRU 102, WLAN 204, and/or RAN 104/113 may follow similar service operations as an NWDAF in a CN 115. In other representative embodiments, a NWDAF instance in any of a RAN, WTRU, and/or WLAN may introduce added service operations and/or exiting service operations may be modified, such as based on the operating environment (e.g., whether operating at the WTRU 102, WLAN 204, and/or RAN 104/113).

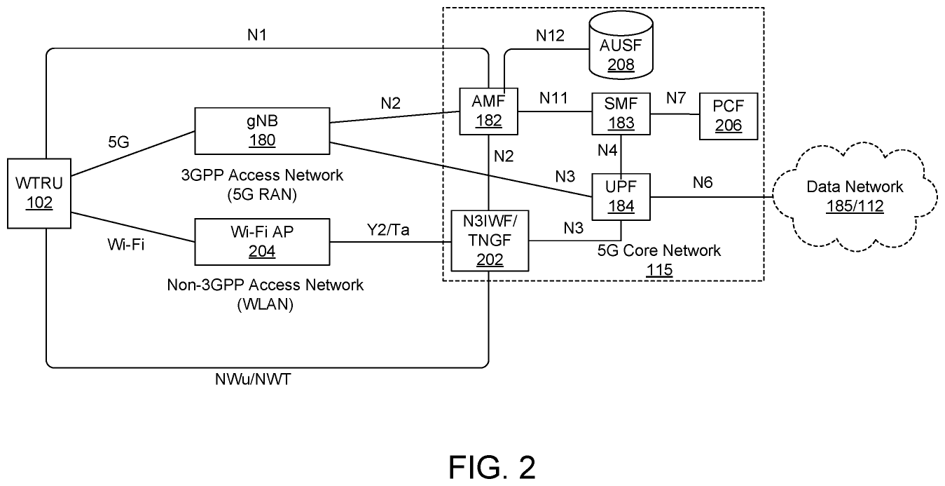

FIG. 5 is an architecture diagram illustrating an example deployment scenario showing the interactions of various SDACs 502-a, 502-b, 502-c with protocol stacks at a WTRU 102, gNB 180 and Wi-Fi AP 204, external components, and other SDACs. In FIG. 5, a Stack Data Analytics Coordinator (SDAC) 500 may communicate with each layer of a protocol stack with a unified API and interface and/or may communicate with external components, such as NWDAFs 504-a, 504-b, 504-c, 504-d and ADRFs 506-a, 506-b, 506-c, 506-d in a WTRU 102, RAN 113, WLAN 204 and/or CN 115. For example, SDAC interaction with protocol stacks (e.g., LLC, MAC, PHY of a Wi-Fi stack 508 and/or RRC, PDCP, RLC, MAC, PHY of a 5G stack 510) may occur using Nsdac, Nwifi, N5g, and Napp interfaces. As an example, the SDAC 502-a at the WTRU 102 may access to (e.g., all) layers of the protocol stack (e.g., both Wi-Fi and 5G-NR) but for simplicity one Nwifi interface and one N5g interface are shown. Other access technologies such as 4G/LTE, Li-Fi, Satellite and/or wired systems may similarly interact with any of the SDACs. Security aspects of such interactions may be beyond the scope of the disclosure.

For example, a SDAC 502 may facilitate interaction between a protocol stack (e.g., LTE, 5G-NR, Wi-Fi) 508, 510 with different components such as database (e.g., ADRF 506), AI and/or ML engine (e.g., NWDAF 504 and/or applications running at a WTRU 102). A SDAC 502 may share some similarities with a DCCF in the CN 115 that allows an NWDAF 504-d to interact with the CN functions such as an AMP 182, SMF 183, UPF 184, AF 512 and the like. However, unlike the DCCF, the SDAC 502 may particularly interact with the radio protocol stack, and local and/or remote controller (e.g., analytics provider) in order to manage operations within the protocol stack and elsewhere. Additionally, the SDAC 502-a in the WTRU 102 may interact with applications 514 running at the WTRU 102, such as by the Napp interface, allowing the applications 514 at the WTRU 102 to access analytics and various statistics and measurements that are collected from various radio protocol stacks at the WTRU 102 or elsewhere (e.g., RAN 113/180, CN 115, and/or WLAN 204).

In certain representative embodiments, SDAC facilitated interactions may include the exchange of telemetry and/or control messages, such as enabling AI and/or ML techniques to be used for managing one or more network functionalities at any of the WTRU 102, RAN 113/180, WLAN 204 and/or CN 115. For example, the one or more network functionalities in case of the multi-connectivity may include any of (1) data packet scheduling, (2) traffic steering on per WTRU basis, (3) inter-RAT packet retransmission, (4) inter-RAT packet redundancy, (5) RAT selection at the WTRU 102, (6) frequency selection by changing the RFSP index, (7) cell and/or Wi-Fi AP selection at the WTRU 102, and/or (8) (e.g., intelligent) beamforming in the Wi-Fi AP 204 and/or gNB 180. Any of such network functionalities may be applied in emerging 5G and/or 6G applications that may require high data rates, ultra-low latency, and/or ultra-high reliability simultaneously. In other examples, any of such network functionalities may be handled by optimisation approaches which may be designed to optimise network operation according to a (e.g., a single) key performance indicator (KPI) and/or one type of service which is not sufficient to perceive the diversity and high amount of data in the next-generation wireless network.

As shown in FIG. 5, for example, a SDAC 502-a may reside outside the protocol stack (e.g., at the WTRU 102) while interacting with the protocol through (e.g., known) interfaces and/or APIs. For example, using existing interfaces and/or APIs may allow the SDAC 502-a to be deployed along side of different radio protocol stack technologies 508, 510 (e.g., protocol stacks of different radio access technologies). In certain embodiments, a protocol stack may reside at a kernel space or a user space, such as depending on whether to consider conventional (e.g., hardware-based) or Open RAN based (e.g., software-based) architectures. The various embodiments described herein may be used for both protocol stack architectures.

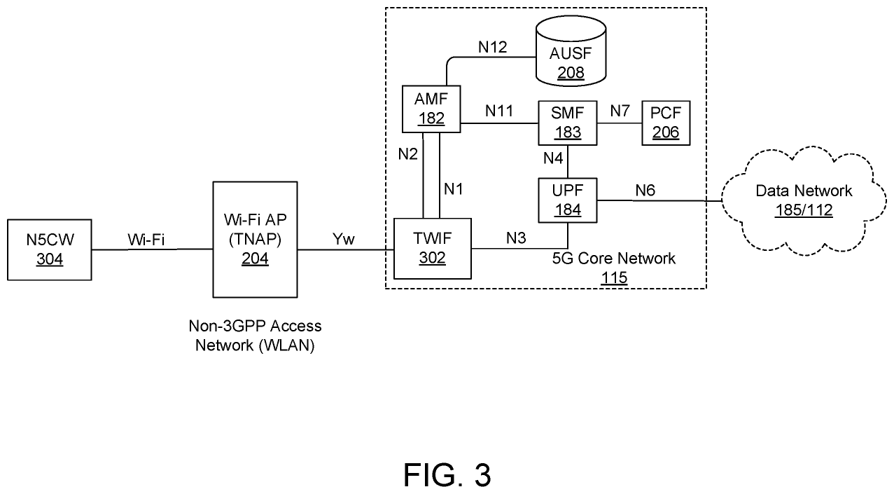

FIG. 6 is an architecture diagram illustrating an example deployment scenario showing a disaggregated 5G NR protocol stack. In certain representative embodiments, more than one SDAC 502 may be deployed, such as when a gNB 180 is disaggregated into any of a DU (Distributed Unit) 602, a CU (Centralized Unit) 604, and/or a Radio Unit (RU) 606. As shown in FIG. 6, RRC and PDCP layers are in a Centralized Unit (CU) 604 while RLC, MAC and PHY (L2) layers are in a Distributed Unit (DU) 602. An instance of an SDAC 502-b may be used for the CU 604 and/or the DU 602. As shown in FIG. 6, interaction between SDACs 502 and a disaggregated 5G-NR protocol stack (e.g., among the DU 602, CU 604, and/or RU 606) are illustrated. Multiple SDACs can be used to interact with a disaggregated protocol stack (e.g., a SDAC 502-b may interact with layers at the CU 604 and another SDAC 502-b may interact with layers at the DU 602).

In certain representative embodiments, a (e.g., any) SDAC 502 may be disposed outside a (e.g., any) protocol stack. As an example, for a cellular protocol stack, a SDAC 502 may be implemented within the RRC layer, such as where the RRC layer already has access to several measurements across layers of the protocol stack as well as WTRUs 102 and the RRC layer may control one or more (e.g., key) parameters within the cellular stack.

In certain representative embodiments, a SDAC 502 may collect monitoring information and measurements from the protocol stack and may store them in a local and/or remote database (e.g., within any of the WTRU 102, RAN 113/180, and/or CN 115), such as shown FIGS. 5 and 6. For data collection, for example, the SDAC 502-c may interact with a Wi-Fi controller 610 in the case of the Wi-Fi stack and with the RRC layer in the case of the cellular stack. A SDAC 502-a, 502-b, 502-c may interact with each layer of the respective protocol stack provided that a layer of the protocol stack may be an analytics consumer.

As shown in FIGS. 5 and 6, several SDACs (e.g., 502-a, 502-b, 502-c) may be disposed in any (e.g., each) of the WTRU 102, RAN 113/180, and/or WLAN 204. The SDACs may interact with each other and/or an instance of the NWDAF 504-d in the CN 115. The NWDAF 504-d in the CN 115 may also interact with other NFs, such as any of the UPF 184, PCF 206, SMF 183, and/or AMF 512. In FIGS. 5 and 6, the external communication interfaces may be used over RESTful APIs (e.g., HTTP) and/or via a messaging framework. The latter approach (e.g., a messaging framework such as Apache Kafka) may be implemented, for example, given that it allows multiple entities to subscribe to receive monitoring data, control messages, and/or analytics from a particular publisher (e.g., SDAC 502) or a set of publishers (e.g., SDACs 502), such as with low latency, as described later. For example, a WTRU 102 may run (e.g., execute) an AI and/or ML inference, and the SDAC 502-a at the WTRU 102 may subscribe to receive telemetry information from other SDACs 502 (e.g., SDAC(s) 502-b at gNB and/or SDAC 502-c at WLAN AP 204). For example, the CN 115 may (e.g., execute) an AI and/or ML inference, such as to steer a WTRU's traffic at the UPF 184 in case of ATSSS, the CN 115 (e.g., SDAC 502 at the CN 115) may subscribe to receive telemetry information (e.g., directly) from any of the WTRU 102, gNB 180, Wi-Fi AP 204 and/or UPF 184.

In FIGS. 5 and 6, an SDAC 502 may use the illustrated interfaces for communicating with a respective protocol stack. For example, the interfaces (e.g., in the WTRU 102, RAN 113/180, and/or Wi-Fi AP 204) may be a fast Inter-Process Communication (IPC) communication mechanism, which may be similar to the NetLink socket in the Linux Kernel which provides a fast interaction between the Linux Kernel space and user space.

Apart from the communication interfaces, a set of (e.g., well-defined) APIs and service operations may be defined for interactions between a SDAC 502 and each layer of a protocol stack as well as other components. Service operations should allow a SDAC 502, for example: (i) to register for receiving data from data providers to serve its data consumers (which are typically analytics providers or applications) and/or (ii) to subscribe for receiving analytics from an analytics provider or a set of analytics providers to serve its analytics consumers. Other (e.g., new) APIs may also be defined for a protocol stack to control some key parameters. For example, control may include any of to adjust the RLC buffer size dynamically, activate/deactivate the RLC AM, delete a set of PDUs from the RLC buffer, cancel pending retransmission at MAC layer, adjust number of retransmissions at MAC and/or RLC layer, and/or modify QoS indications for a set of RLC buffer (e.g., changing bearers for streams or a set of packets dynamically).

In certain representative embodiments, to enable interactions among different SDACs 502 operating in the WTRU 102, RAN 113/180, and/or WLAN 204 as well as NWDAF 504 instance(s) in the CN 115, each SDAC 502 may be separately (e.g., uniquely) identified. For example, SDACs 502 may identified by a SDAC ID. A SDAC ID may be generated (e.g., along with a corresponding entity ID) as follows:
For an WTRU SDAC 502-a: a SDAC ID may be generated based on a Subscription Permanent Identifier (SUPI);
For a RAN/gNB SDAC 502-b: a SDAC ID may be generated based on any of a NR cell identity (NCI) and/or a NR cell global identity (NCGI) which concatenates a PLMN ID and a NCI;
   In cases where a gNB is disaggregated into CU and DU, and a SDAC is also deployed in gNB-DU: a SDAC ID may be generated based on gNB-DU-ID.
For a WLAN SDAC 502-c: a SDAC ID may be generated based on a basic service set identifier (BSSID).

### Interactions Between SDACs, NWDAF and ADRF in RAN

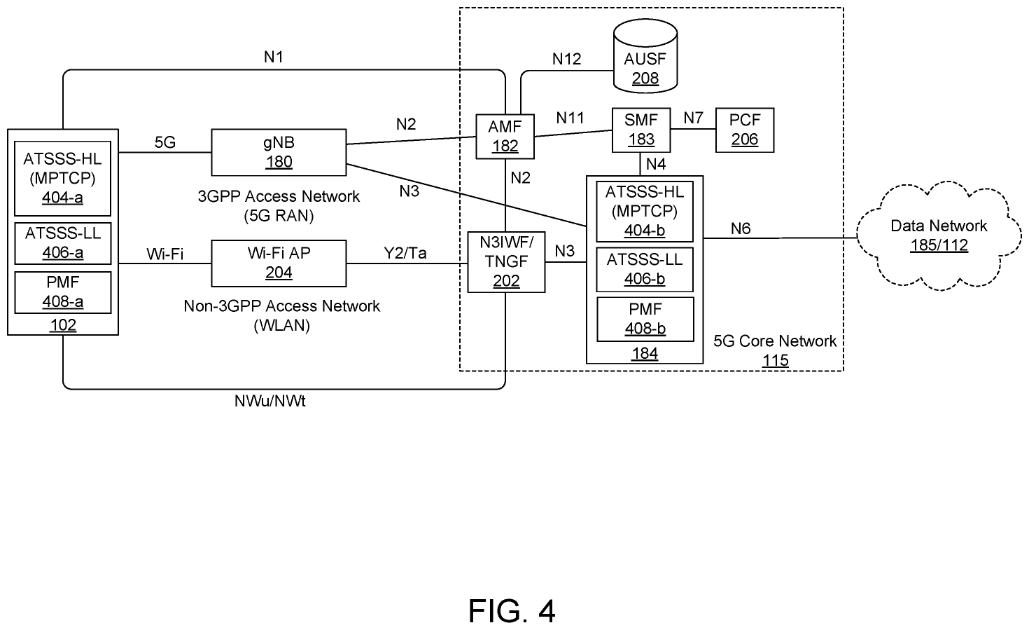

FIG. 7 is an architecture diagram illustrating an example deployment scenario showing interactions between SDACs 502, NWDAF 504, ADRF 506 and a base station (e.g., gNB 180).

In certain representative embodiments, the MAC layer at a gNB 180 may be the analytics consumer and may seeks to use analytics information, such as for resource scheduling (e.g., at the gNB 180). For example, analytics information may be provided to a MAC scheduler at a gNB 180 from an instance of a NWDAF 504-b in the RAN.

As shown in FIG. 7, the layers in the gNB 180 are the data provider while only the MAC layer is the analytics consumer. In this example, the NWDAF 504-b is the analytics provider and the ADRF 506-b is a database for holding both data and/or analytics.

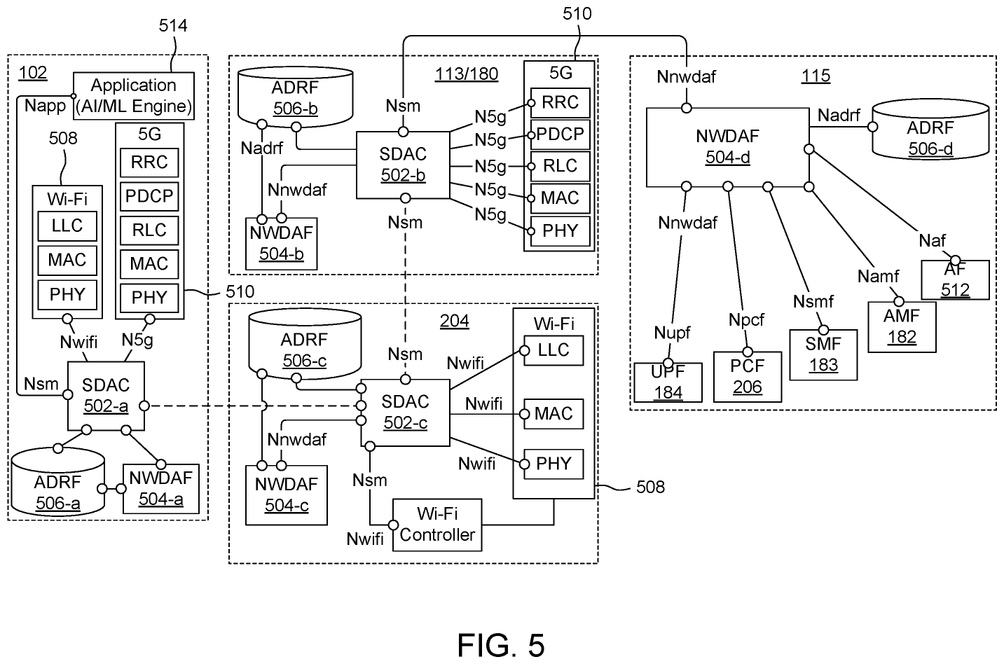

FIG. 8A is a first portion of a procedural diagram illustrating an example of a communications flow which includes interactions between an analytics consumer 802 (e.g., at a MAC layer), SDAC 502-b (e.g., at a gNB 180), NWDAF 504-b (e.g., at a RAN), a ADRF 506-b (e.g., at a RAN), and a data source 804 (e.g., one or more layers of the gNB protocol stack). FIG. 8B is a second portion of the procedural diagram illustrating the example of the communications flow continuing from FIG. 8A. For example, the communications flow in FIGS. 8A and 8B may be applied to the deployment scenarios shown above such as, but not limited to, FIG. 7.

At 806 in FIG. 8A, an analytics consumer 802 (e.g., a data consumer such as a gNB MAC scheduler) may subscribe to analytics information via a SDAC 502. In other embodiments, any layer of an access technology protocol stack may be an analytics consumer 802. For example, the analytics consumer may call a Nsdac_DataManagement_Subscribe service operation. This service operation may comprise several parameters such as NWDAF service operation, Analytics Specification (Analytics ID, target of reporting, etc.), Formatting Instructions, Processing Instructions, NWDAF (or NWDAF-set) ID, ADRF information, and so on. As an example, any of analytics ID(s), NWDAF ID(s), ADRF information (e.g., for storing analytics information, and/or notification endpoints (e.g., NWDAF(s) & ADRF(s)) may be provided at 806.

As shown in FIG. 8A, the NWDAF 504-b instance is hosted in the RAN 113/180, close to the SDAC 502-b. However, the NWDAF instance 504 may also be in a center cloud or in the core network 115. In certain embodiments, an SDAC 502 may need to interact with several NWDAFs 504 to handle the analytics consumer request. For example, an analytics information aggregation procedure may be used when multiple NWDAFs 504 are involved.

In certain representative embodiments, the SDAC 502-b may be the only component which has direct access to the protocol stack of different technologies (such as gNB 180, WLAN 204, WTRU 102).

At 808 in FIG. 8A, the SDAC 502 may find (e.g., locate) an appropriate NWDAF 504 instance (or a set of NWDAFs) for requested analytics, such as where the NWDAF 504 instance(s) is not provided by the analytics consumer 802. A similar process holds for an ADRF 506 scenario.

At 810 in FIG. 8A, the SDAC 502 may determine whether analytics requests are already being collected (e.g., to prevent the same analytics from being collected twice). If requested analytics is or are already available at the SDAC 502 which are to be provided to other consumers, then the collected analytics information may be reused.

At 812 in FIG. 8A, the SDAC 502 may send a subscription request to a selected NWDAF 504 instance. For example, the SDAC 502 may send the subscription request via a service operation (e.g., via a Nnwdaf_AnlyticsSubscription_Subscribe).

At 814 in FIG. 8A, if the NWDAF 504 can provide such information, then it responds to the subscription request with a service operation (e.g., Nwdaf_AnalyticSubscription_Subscribe response) which includes a Subscription Correlation ID.

At 816 in FIG. 8A, the NWDAF 504 may check if it has all means to produce the requested analytics. For example, the NWDAF 504 may request and/or gather missing data to fulfill the request. As an example, the NWDAF 504 may need to obtain data from the gNB 180, and may call a service operation to the SDAC 502 (e.g., Nsdac_DataManagement_Subscribe) so that it can receive notification for requested parameters across the gNB protocol stack(s). In this service operation message, the NWDAF 504 may indicate whether requested data should be stored in an ADRF 506.

At 818 in FIG. 8A, the SDAC may determine whether the requested data is available at itself (e.g., the SDAC 502) and/or it should be stored in the ADRF 506 instance, such as by the SDAC 502 or another data provider directly. In FIG. 8, it is assumed that data may be stored in the ADRF 506 instance. In certain embodiments, the SDAC 502 may hold collected data temporarily (e.g., in its memory) if it has several analytics consumers 802. This may depend on SDAC implementation. The SDAC 502 may fetch data from the ADRF 506 or request the NWDAF(s) 504 to fetch it directly.

In certain representative embodiments, a data source 804 may be a protocol stack. For example, the SDAC 502 may handle interactions and store collected data provided by the protocol stack in an ADRF 506. This way the protocol stack does not need to interact with external components such as the ADRF 506 which may be located outside the mobile provider network. Instead, the SDAC 502 may be capable to securely interact with external components.

At 820 in FIG. 8A, the SDAC 502 may send a subscription message to the ADRF 506 (e.g., a Nadrf_DataManagemnt_StorageSubscribeRequest), asking the ADRF 506 to subscribe to the SDAC 502 in order to get notifications for data that needs to be stored.

At 822 in FIG. 8A, the ADRF 506 may check if the same data is already stored or is being stored based on information sent at 820.

At 824 in FIG. 8A, the ADRF 506 may send the relevant stored data, assuming the relevant data is stored by the ADRF 506. Otherwise, the procedure from 822 may skip 824.

At 826 in FIG. 8A, the ADRF 506 may send a data subscription request to the SDAC 502 to get a notification when data becomes available, such as via Nsdac_DataManagement_Subscribe. The ADRF 506 may provide its notification endpoint address and a notification correlation ID to the SDAC 502 in the request.

At 828 in FIG. 8A, the SDAC 502 may subscribe to at least one data source 804 (e.g., one or more layers of the gNB protocol stack, such as RRC, RLC, MAC, PHY), to get notifications for one or more parameters and/or one or more events. In some embodiments, the SDAC 502 may use a (e.g., respective) Nnf_EventExplosure_Subscribe service operation. At 830, the SDAC 502 may subscribe to a data source 804. For example, in 830-a, 830-b, and/or 830-c, the Ngnb_EventExplosure_Subscribe may be sent by the SDAC 502 to interact with the data source 804 (e.g., the gNB protocol stack), such as to interact with RRC, RLC and MAC layers, respectively.

At 832 in FIGS. 8A and 8B, the data source 804 may generate and/or send a notification, such as via Nnf_EventExplosure_Notify, after the requested data is available. For example, at 834, the notification may be sent for each respective layer (e.g., data source). For example, in 834-a, 834-b, 8 and/or 34-c, the data source 804 (e.g., gNB 180) may notify the SDAC 502 via a (e.g., respective) Ngnb_EventExplosure_Notify operation with respect to data from the subscribed layers of the protocol stack. For clarity, 832 is shown in both FIG. 8A and FIG. 8B.

At 836 in FIG. 8B, the ADRF 506 may store any of the notifications (e.g., received at 13.) via Nsdac_DataManagement_Notification.

At 838 in FIG. 8B, the SDAC 502 may notify the NWDAF 504 and/or other notification endpoints (e.g., provided by NWDAF 504) with the relevant data via a Nsdac_DataManagement_Notify service operation. For example, the collected data may be aggregated to include several notifications from data source(s) 804. Multiple notifications may be aggregated into a single message which may (e.g., significantly) reduce signaling overhead. In certain embodiments, the aggregation may be performed according to formatting instructions (e.g., provided by the analytics consumer 802).

At 840-a and 840-b in FIG. 8B, the NWDAF 504 may notify the SDAC 502 via a Nnwdaf_AnalyticsSubscription_Notify service operation. For example, in 840-a, and/or 840-b, the NWDAF 504 may notify the SDAC 502 via a (e.g., respective) Nnwdaf_DAnalyticsSubscription_Notify operations, which may relate to respective aggregations of collected data.

At 842-a and 842-b in FIG. 8B, the SDAC 502 may send analytics to any (e.g., all) notification endpoints identified the by analytics consumer(s) via Nsdac_DataManagement_Notify. Analytics information sent by the SDAC 502 to the notification endpoints may be formatted (e.g., by the SDAC 502), such as to conform to delivery requirement of (e.g., each of) the analytics consumers. In certain embodiments, the SDAC 502 may store the analytics information in the ADRF 506, such as where the storage of the analytics information is requested by the analytics consumer 802 and/or SDAC configuration.

In certain embodiments, the (e.g., each) analytics consumer 802 may fetch analytics information (e.g., regularly) either from the SDAC 502 and/or ADRF 506 rather than waiting for the SDAC notification.

At 844 in FIG. 8B, an unsubscribe procedure may be performed to unsubscribe with the respect to the subscribe procedure at 830. At 846 in FIG. 8B, an analytics consumer 802 may unsubscribe (e.g., via Nsdac_DataManagement_Unsubscribe) to stop receiving (e.g., requested) analytics information from the SDAC 502.

At 848 in FIG. 8B, the SDAC 502 may unsubscribe (e.g., via Nnwdaf_AnalyticsSubscription_Unsubscribe) to stop receiving requested analytics information from the NWDAF 504.

At 850 in FIG. 8B, the NWDAF 504 may operate similarly to 846 to unsubscribe from the SDAC 502 to stop receiving requested analytics information.

At 852 in FIG. 8B, the SDAC 502 may also unsubscribe from any related data source(s) 804, such as the gNB protocol stack. In other representative embodiments, a related data source 804 may be at any of a WTRU 102 and/or another base station, such as a Wi-Fi AP 204.

At 854 in FIG. 8B, the SDAC 502 may determine that previously requested data (e.g., analytics information) is no longer to be stored in the ADRF 506.

At 856 in FIG. 8B, the SDAC 502 may send a subscription removal to the ADRF 506.

At 858 in FIG. 8B, the ADRF 506 may (e.g., via call Nsdac_DataManagement_Unsubscribe) to stop receiving notifications from the SDAC 502.

### SDAC Interactions via Messaging Framework

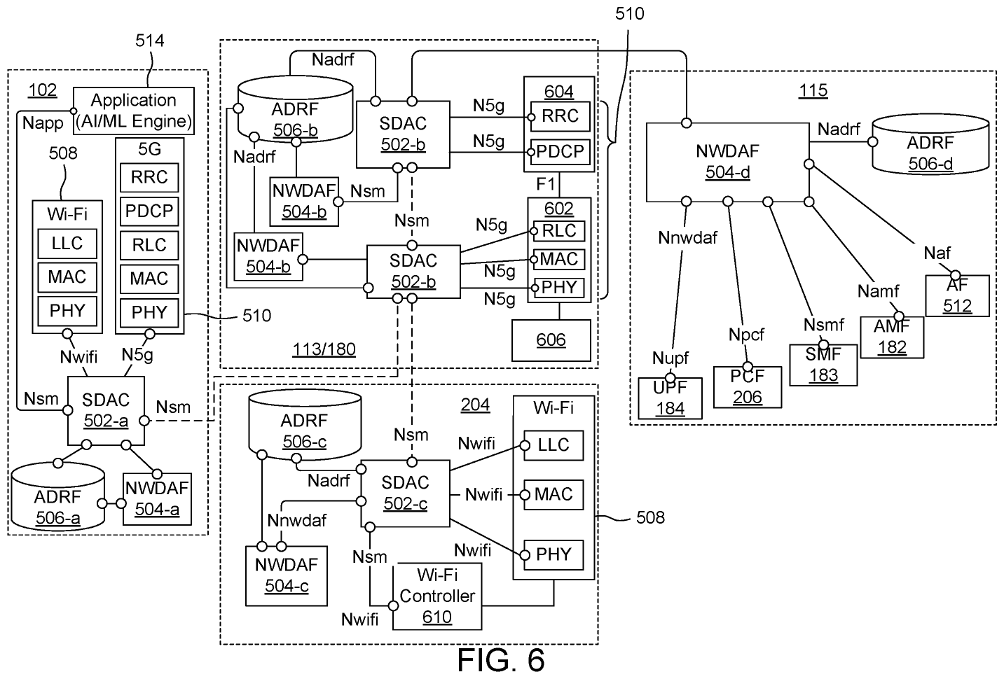

FIG. 9 is an architecture diagram illustrating an example deployment scenario where a Messaging Framework 902 may be utilized. In certain representative embodiments, a Messaging Framework 902 may extend data and/or analytics information exchange so that it may be exchanged across different components within 3GPP systems as well as non-3GP systems in an optimal manner and/or with greater flexibility. For example, multiple NWDAFs 504 and/or applications running at one or more WTRUs 102 may subscribe to particular measurements from (e.g., layers of) a radio protocol stack. Data consumers may be notified via the Messaging Framework 902 once subscribed measurements become available. As shown in FIG. 9, any of the SDACs 502-a, 502-b, 502-c may configure all parties (e.g., analytics consumers and providers) to use the Messaging Framework 902 to interact. For example, the SDAC 502 may not notify the analytics consumers 508, 510, 514, 802 directly and instead uses the Messaging Framework 902. For example, the Messaging Framework 902 may be a data bus (e.g., implemented by Apache Kafka).

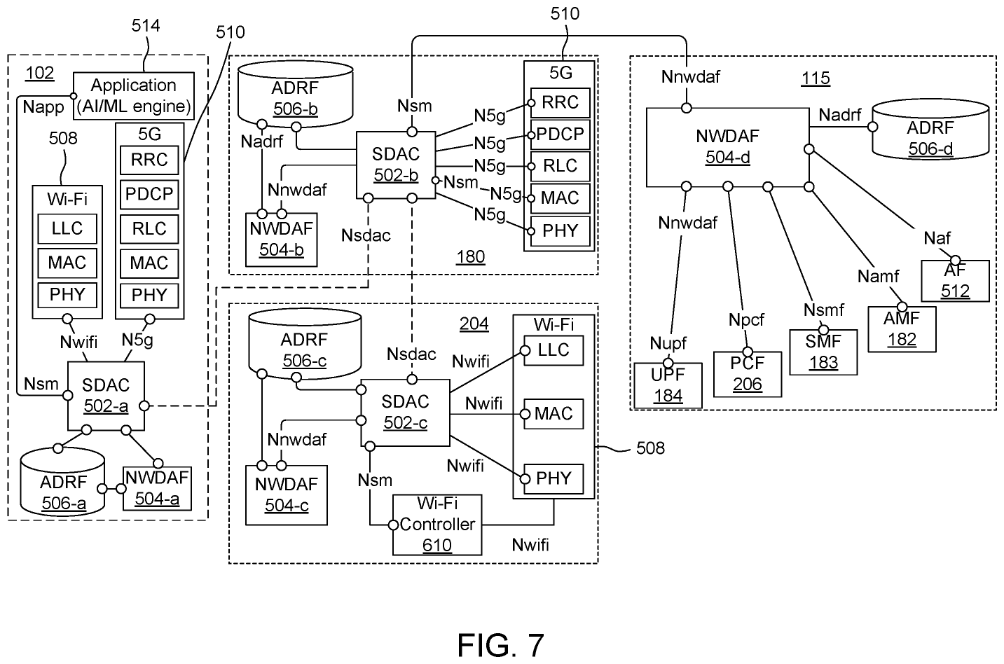

FIG. 10 is a procedural diagram illustrating an example of a communications flow which includes interactions between a SDAC 502 and a NWDAF 504 via a Messaging Framework 902. As shown in FIG. 10, the Messaging Framework 902 may provide analytics to a gNB 180 (e.g., MAC scheduler) as an analytics consumer 802. In other representative embodiments, there may be one or more analytics consumers 802 located elsewhere as described herein (e.g., at the WTRU 102, Wi-Fi AP 204 and/or CN 115).

At 1002 in FIG. 10, an analytics consumer 802 (e.g., any of Protocol Stack, NFs, and/or OAM) may subscribe to analytics information (e.g., via a SDAC 502), such as by calling the Nsdac_DataManagement_Subscribe service operation. For example, this service operation may include parameters such as any of a NWDAF service operation, an Analytics Specification (e.g., Analytics ID, target of reporting, etc.), Formatting Instructions, Processing Instructions, NWDAF (or NWDAF-set) ID, ADRF information, and/or other parameters. As another example, the subscription request may include any of Analytics ID(s), NWDAF ID(s), ADRF information (e.g., on condition that requested information is to be stored), and/or Notification endpoints (e.g., NWDAF(s) 504 and/or ADRF(s) 506).

As shown in FIG. 9, the NWDAF 504 instance may be hosted in the RAN (e.g., with the SDAC 502). However, the NWDAF 504 instance may also be in a center cloud or in the core network. NWDAF ID may be provided by the analytics consumer 802 or it can be selected by SDAC 502.

At 1004 in FIG. 10, the SDAC 502 may find (e.g., locate) an appropriate NWDAF 504 instance (or a set of NWDAFs) for requested analytics information, such as where the NWDAF 504 instance is not provided by the analytics consumer 802. As another example, the ADRF 506 may also find (e.g., locate) an appropriate NWDAF 504 instance (or a set of NWDAFs) for requested analytics information. In certain embodiments, a (e.g., any or every) layer of a technology protocol stack could be an analytics consumer 802 and/or data source 804. For example, a single piece of analytics information may need several inputs (e.g., analytics data point(s)) from multiple NWDAFs 504 (e.g., potentially located in different part of 5G systems such as RAN 113, Core 115, WTRU 102) and/or SDACs (e.g., 502-a, 502-b, 502-c).

At 1006 in FIG. 10, the SDAC 502 may determine whether (e.g., similar) analytics information is already being collected. For example, this may prevent analytics that are being collected by other consumers (e.g., from being redundantly collected). Like DCCF, the SDAC 502 adds the new consumer to the list of active consumers 802 of the requested analytics.

At 1008 in FIG. 10, the SDAC 502 may setup the MFAF 1002 (e.g., via a Nmfaf_3daDataManagement_Configure service operation). For example, the MFAF 1002 may pass notifications received from the NWDAF 504 to a (e.g., any) notifications endpoint, such as through a messaging framework (e.g., Apache Kafka). In some embodiments, the MFAF 1002 may format and process messages received into and/or sent out of the MFAF 1002.

At 1010 in FIG. 10, the SDAC 502 may not send the MFAF 1002 notification information, such as where the selected NWDAF 504 does not send analytics to the MFAF 1002. For example, the MFAF 1002 may select a MFAF Notification Target Address (e.g., a MFAF Notification Correlation ID) and may send it to the SDAC 502 (e.g., via Nmfaf_3daDataManagement_Configure Response message).

At 1012 in FIG. 10, the SDAC 502 may subscribe with the selected NWDAF 504 to get requested analytics by an analytics consumer 802 (e.g., via Nnwdaf_Anayltics_Subscribe). For example, the SDAC 502 may set (e.g., configure) a Notification Target Address (e.g., Notification Correlation ID) to a MFAF Notification Target Address (e.g., MFAF Notification Correlation ID) received at 1008 in FIG. 10. For example, the SDAC 502 may add the analytics consumer 802 to a list of analytics consumers that are subscribed for the requested analytics information.

At 1014 in FIG. 10, the NWDAF 504 may subscribe (e.g., via Nsdac_DataManagement_Subscribe service operation) with the SDAC 502 to collect relevant data (e.g., analytics information from the protocol stack connected to the SDAC 502).

At 1016 in FIG. 10, the SDAC 502 may check if requested data is already being collected by other analytics consumers 802 and/or whether the collected data should be stored in an ADRF 506

At 1018 in FIG. 10, the SDAC 502 may send a request (e.g., Nmfaf_3daDataManagement_Configure service operation) to setup the MFAF 1002 to map notifications received from a (e.g., any) data source 804 (e.g., the gNB protocol stack) to outgoing notifications which are to be sent to endpoints (e.g., NWDAF(s) 504 and/or ADRF(s) 506). For example, the SDAC 502 may need to configure the MFAF 1002 before interacting with data sources 804 so that data sources can interact with MFAF 1002 after receiving required information from the SDAC 502.

At 1020 in FIG. 10, the SDAC 502 may register with the (e.g., any) data source 804 and/or request the data source 804 to register with the MFAF 1002 for any notifications related to the SDAC 502.

At 1022 in FIG. 10, the (e.g., every relevant) data source 804 may notify the MFAF 1002 when requested data and/or event information becomes available.

At 1024 in FIG. 10, the MFAF 1002 may deliver messages to the (e.g., every relevant) analytics consumer 802. For example, the NWDAF 504 may be the data (e.g., analytics) consumer 802.

At 1026 and 1030 in FIG. 10, the NWDAF 504 may perform processing (e.g., aggregating and/or formatting) of the received analytics information. The NWDAF 504 may notify the MFAF 1002 of the received analytics information at 1026 and 1030.

At 1028 and 1032 in FIG. 10, the MFAF 1002 may deliver and/or notify the (e.g., each) analytics consumer 802 after receiving the (e.g., new) analytics information from the NWDAF 504. For example, the MFAF 1002 may process the analytics information using one or more rules (e.g., formatting and processing instructed by each analytics consumer 802) to prepare the (e.g., each) notification.

At 1034 in FIG. 10, the analytics consumer 802 may perform an unsubscribe procedure. For example, at 1036, the analytics consumer 802 may send a message to the SDAC 502 to unsubscribe from an analytics notification, such as when the analytics consumer 802 no longer needs the requested analytics information.

At 1038 in FIG. 10, the SDAC 502 may send a similar message to unsubscribe to the NWDAF 504. For example, the SDAC 502 may provide a Notification Correlation ID.

At 1040 in FIG. 10, the SDAC 502 may request (e.g., signal) to the (e.g., each) data source 804 to stop sending notifications to the MFAF 1002.

At 1042 in FIG. 10, the SDAC 502 may request (e.g., signal) the MFAF 1002 to remove the configuration for the corresponding interactions (e.g., to remove the subscription information relating to the analytics consumer at 1002 in FIG. 10).

### Interactions Between SDACs and NWDAFs in CN

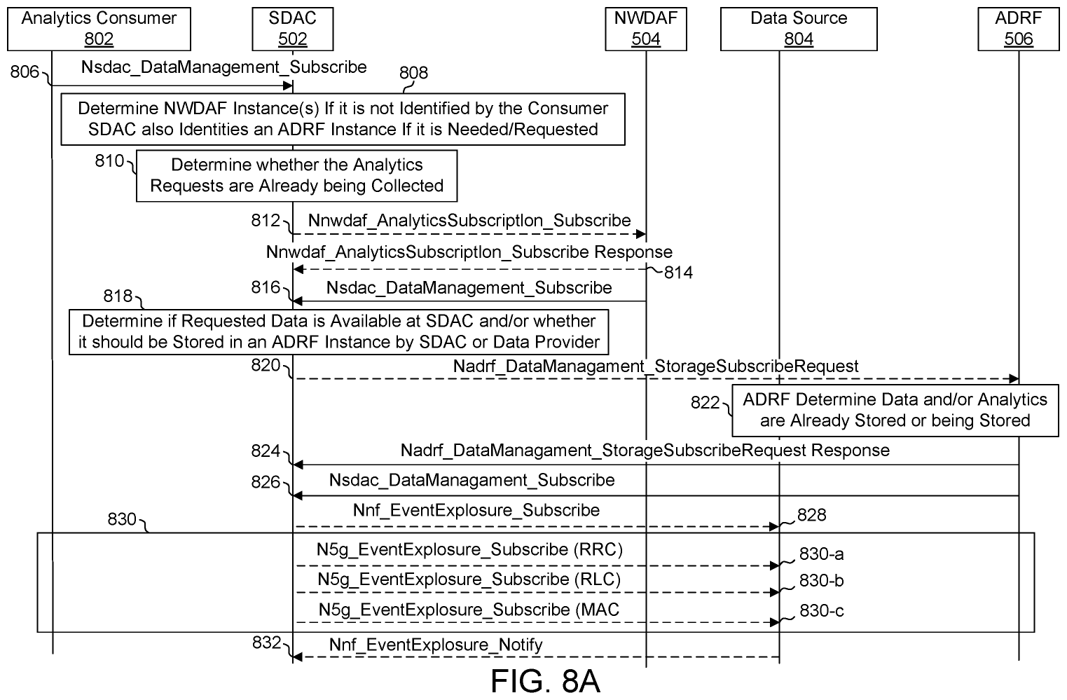

FIG. 11 is an architecture diagram illustrating an example deployment scenario where an Access Traffic steering, switching, and splitting (ATSSS) framework may be used to steer WTRU traffic (e.g., downlink traffic). In FIG. 11, a UPF 184 may include a ATSSS-HL (e.g., a MPTCP Proxy) function 1102 and a PMF 1104. A WTRU 102 may include a ATSSS-HL (e.g., a MPTCP Proxy) 1102 and a PMF 1104. For example, in FIG. 11, the UPF 184 may request the NWDAF 504-d to provide analytics for traffic steering and/or re-transmission functions, such as via an AnLF and/or MTLF. The UPF 184 may provide measurements from the PMF 1104 to the NWDAF 504-d (e.g., the UPF 184 acts as both a data provider and an analytics consumer simultaneously). The NWDAF 504-d may interact with any SDACs 502 in RAN 113/180, WLAN 204 and/or WTRU 102 to collect required data to produce the requested analytics.

In certain representative embodiments, a SDAC 502 may enable one or more NWDAFs 504 at the CN 115 to access radio parameters at any of the WTRU 102, RAN 113/180, and/or WLAN 204.

As shown in FIG. 11, a data consumer 802, such as a UPF 184, may subscribe to get analytics information from an NWDAF 504-d instance in the CN 115 (e.g., through the Nnwdaf interface). As an example, an (e.g., internal) algorithm of the NWDAF 504 may use and/or require several network related data parameters (e.g., measurements and statistics) from different radio protocol stacks and/or layers and/or other entities within the (e.g., 3GPP) network to make an intelligent decision about how to steer the WTRU's downlink traffic across different access links (e.g., cellular and Wi-Fi). For example, the measurement and/or statistics information may be related to any of a total number of connected users at the gNB 180 and/or the Wi-Fi AP 204, the WTRU's downlink traffic load and/or type, a history of the total number of retransmissions (e.g., at the MAC layer), a prediction of the WTRU's mobility, available radio resources at the gNB 180 and/or Wi-Fi AP 204, a history of allocated resource blocks to the WTRU 102 (e.g., by the gNB's MAC scheduler), the head-of-line delay of the RLC queue, and/or other parameters.

In some embodiments, the NWDAF 504 may (e.g., directly) collect data from any NFs in the CN 115, such as the AMF 182, SMF 183, PCF 206 and/or UPF 184. For example, the NWDAF 504 may subscribe to the UPF 184 (e.g., via the Nupf interface) to collect measurements provided by the PMF 1104 (e.g., RTT between WTRU and UPF).

In FIG. 11, the NWDAF 504-d may (e.g., next) subscribe to the SDAC 502 instances in the RAN (e.g., gNB 180), WLAN (Wi-Fi AP 204) and/or WTRU 102 to get the relevant data required and/or used for a AI and/or ML algorithm (e.g., through the Nsdac interface). After a SDAC 502 receives such a request, the SDAC 502 may subscribe to a corresponding protocol stack it is interacting with (e.g., via either the Nwifi or N5g interface) and/or other components, such as where the requested data is not already being collected by the SDAC 502 and/or it is not available in a database of an ADRF 506.

When a protocol stack 508, 510 notifies the SDAC 502 with the requested data, the SDAC 502 may send a notification to the corresponding NWDAF 504 in the CN 115. For example, the notification may be sent through a messaging framework (e.g., the MFAF 1002).

For example, the protocol stack 508, 510 may notify NWDAF 504 directly. multiple consumers seeking to get identical data from the protocol stack 508, 510 may cause bottlenecking issues relative to the protocol stack 508, 510. Sending data from the protocol stack 508, 510 to the data consumers via the SDAC 502 may allow for efficient coordination between data providers (e.g., analytics sources) and data consumers. This may reduce the total number of messages that need to be exchanged in the network to move the requested information from the data providers to the data consumers.

In FIG. 11, the NWDAF 504 may produce the requested analytics for the UPF 184. For example, the NWDAF 504 may input the requested data by inputting the collected data from one or more of the SDACs 502 to an AI and/or ML algorithm.

### Interaction Between SDACs and NWDAFs in WTRU

In certain representative embodiments, accessing network related measurements and/or statistics may be useful for helping network operations in the CN 115 and/or RAN 113/180 and/or may be used for applications running at a WTRU 102, such as when these applications employ (e.g., execute) intelligent algorithms.

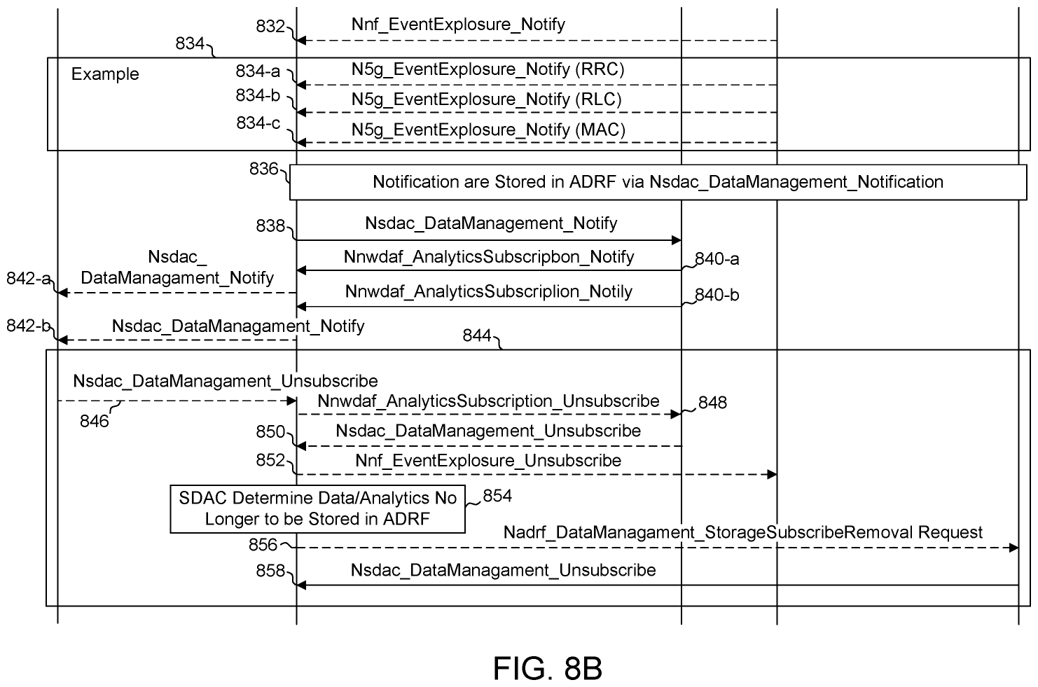

FIG. 12 is an architecture diagram illustrating an example deployment scenario where an application 514 at a WTRU 102 may collect network related measurements and/or analytics information. For example, the application 514 at the WTRU 102 may be an AI and/or ML instance (e.g., engine) executed by the WTRU 102. The application 514 may subscribe to one or more of the SDACs 502 to receive the relevant information. An SDAC 502 may accordingly interact with different entities (e.g., protocol stacks 508, 510 and/or ADRFs 506) to coordinate the collection of the network related measurements and/or analytics information, such as where the same information is not already being collected.

In FIG. 12, an (e.g., AI and/or ML empowered) application 514 may want to access network related measurements and/or analytics information, such as to adapt WTRU behaviour according to underlying network condition. The application, for example, may be high-quality multimedia. In FIG. 12, the WTRU 102 may be assumed to connect to the Internet via two (e.g., both Wi-Fi and cellular (5G-NR)) radio access technologies (e.g., simultaneously).

For example, an AI and/or ML engine run by an application 514 at the WTRU 102 may want to collect network related measurements and/or analytics information. The application may subscribe to an SDAC 502 to get the relevant information. The SDAC 502 may interact with different entities to collect the requested data and/or analytics information, such where the relevant information is not already being collected by another application and/or SDAC.

As shown in FIG. 12, the application 514 may first subscribe to the SDAC 502 (e.g., 502-a at the WTRU 102) to request data and/or analytics information (e.g., one or mor parameters). For example, with the subscription message, the application 514 may ask the SDAC 502 (e.g., 502-a at the WTRU 102) to store the data and/or analytics information in an ADRF 506, such as to maintain a history thereof for later use. The SDAC 502 (e.g., 502-a at the WTRU 102) may check to determine whether the requested data and/or analytics information may already be undergoing collection by itself, such as to avoid redundant collection.

For example, where the data and/or analytics information are already being collected partially by another data consumer but with a different collection interval, the SDAC 502 may readjust the data collection interval, such as by communicating with a corresponding data source. This way the SDAC 502 may serve all data consumers with a single data collection (e.g., message). This may be useful where several applications 514 running at the WTRU 102, and these applications 514 request a (e.g., identical) set of network data and/or analytics information from the SDAC 504. For example, this behaviour of the SDAC 504 may be similar to a DCCF component in the CN 115.

Next, in FIG. 12, the SDAC 502 (e.g., 502-a at the WTRU 102) searches for analytics providers, such as where the application 514 has not provided the IDs of the analytics providers in its subscription request message. In this example, the SDAC 502 (e.g., 502-a at the WTRU 102) may interact with other SDACs 502-b, 502-c at the gNB 180 and the Wi-Fi AP 204 to collect the requested data and/or analytics information. For example, the SDACs 502 may communicate via the Nsdac interface. For example, the SDAC 502 (e.g., 502-a at the WTRU 102) may ask another SDAC 502 (e.g., 502-c at the Wi-Fi AP 204) and/or other SDACs 502 (e.g., 502-b at the gNB 180) to provide analytics information regarding and/or associated with their available radio resources in a particular time interval (e.g., next 100 ms). For example, the SDAC 502 (e.g., 502-a at the WTRU 102) may also request analytics information indicating the underlying network dynamic of the Wi-Fi AP 204 and gNB 180, such as the number of WTRUs joining and/or leaving the gNB 180 and Wi-Fi AP 204 in a specific time window. In this example scenario, the SDAC 502 (e.g., 502-a at the WTRU 102) may request to collect statistics regarding a head-of-line delay of the RLC queue at both WTRU 102 and RAN (e.g., via the N5g interface). The interaction between SDACs 502 is shown with the dotted lines in FIG. 12 (e.g., through the Nsdac interface).

In some embodiments, the SDAC 502 (e.g., 502-c at the Wi-Fi AP 204) may collect data from a Wi-Fi controller rather than directly from any (e.g., each) layer of the Wi-Fi protocol stack 508 as modern Wi-Fi controllers may be capable of collecting statistics and measurements from the Wi-Fi protocol stack 508.

Next, in FIG. 12, the SDAC 502 (e.g., 502-b at the gNB 180) and the SDAC 502 (e.g., 502-c at the Wi-Fi AP 204) may check whether the data and/or analytics information requested by the SDAC 502 (e.g., 502-a at the WTRU 102) are already being collected, such as to avoid redundant collection. If not, the SDAC 502 (e.g., 502-b at the gNB 180) and the SDAC 502 (e.g., 502-c at the Wi-Fi AP 204) may send a subscription request to the corresponding data and/or analytics providers.

For example, the SDAC 502 (e.g., 502-a at the WTRU 102) may not request data and/or analytics information from other SDACs 502 to store the data and/or analytics information in an ADRF 506-b, 506c, 506-d because the SDAC 502 (e.g., 502-a at the WTRU 102) may wish to store them locally in its local database (e.g., a ADRF 506-a at the WTRU 102). However, any SDAC 502 may store any (e.g., all) collected data and/or analytics information in a database (e.g., depending on how the SDAC 502 is configured).

Once the requested data and/or analytics information are collected by the SDACs 502-b, 502-c at the RAN 104/113 and Wi-Fi AP 204, the SDACs 502-b, 502-c at the RAN 104/113 and Wi-Fi AP 204 may notify the SDAC 502 (e.g., 502-a at the WTRU 102). At this point, SDAC 502 (e.g., 502-a at the WTRU 102) may combine any (e.g., all) collected data and/or analytics information and may notify the application 514 via the Napp interface. The application 514 may receive and/or input the data and/or analytics information to an AI and/or ML engine to properly model the network state. For example, the application 514 may determine a correct action for a state determined by the AI and/or ML engine (e.g., to move traffic from the cellular to Wi-Fi network, Wi-Fi network to cellular, duplicate packets to improve the reliability of data delivery, and/or decide on a bitrate, such as for a live video session).

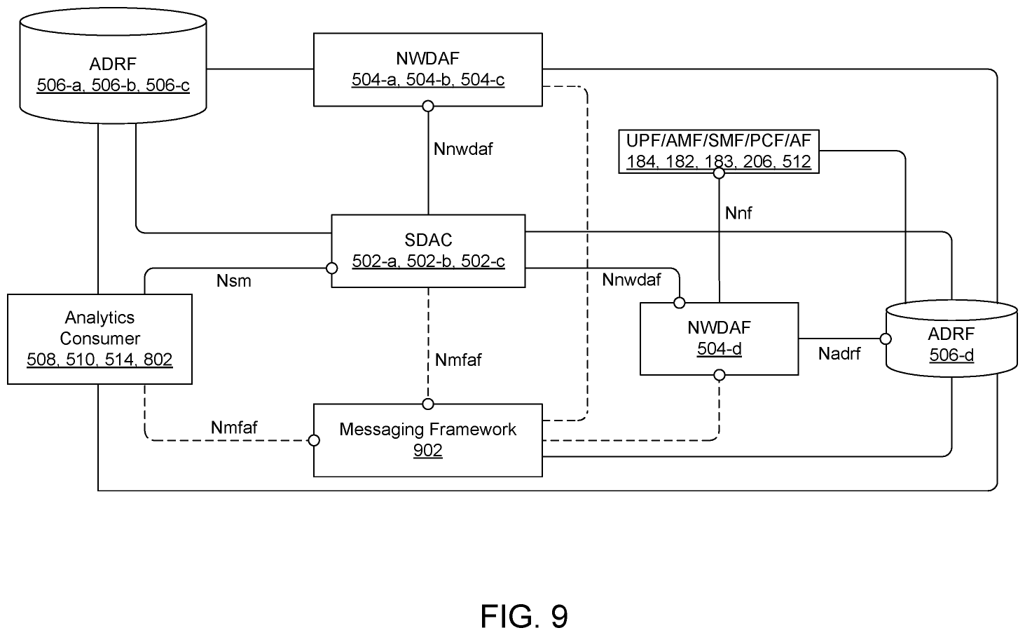

FIG. 13 is a procedural diagram illustrating an example for coordinating provisioning of information between protocol layers of a protocol stack (e.g., 508, 510). For example, the procedure of FIG. 13 may be implemented as a method by a WTRU 102 (e.g., which executes a SDAC 502-a). At 1302, the WTRU 102 may receive (e.g., the SDAC 502-a may receive), from a first protocol layer of a radio access technology (RAT) protocol stack (e.g., 508 or 510) of the WTRU 102, a first request for data, measurement and/or analytics information. The data, measurement, and/or analytics information may be associated with one or more second protocol layers of the RAT protocol stack (e.g., 508 or 510) of the WTRU 102. In some representative embodiments, the first request may be followed by a subscribe message and/or subscription procedure as described herein. At 1304, the WTRU 102 (e.g., the SDAC 502-a) may collect the data, measurement, and/or analytics information from the one or more second protocol layers of the RAT protocol stack (e.g., 508 or 510). For example, the WTRU 102 (e.g., the SDAC 502-a) may collect the requested information using any of the deployment scenarios described herein. At 1306, the WTRU 102 (e.g., the SDAC 502-a) may provide, to the first protocol layer of the RAT protocol stack, the data, measurement, and/or analytics information associated with the first request.

In certain representative embodiments, the collecting of the data, measurement, and/or analytics information from the one or more second protocol layers of the RAT protocol stack (e.g., 508, 510) includes requesting (e.g., subscribing by the SDAC 502-a) the data, measurement, and/or analytics information from a NWDAF 504-a of the WTRU 102.

In certain representative embodiments, the collecting of the data, measurement, and/or analytics information from the one or more second protocol layers of the RAT protocol stack includes obtaining (e.g., by the SDAC 502-a) the data, measurement, and/or analytics information from a NWDAF 504-a of the WTRU 102.

In certain representative embodiments, the collecting the data, measurement, and/or analytics information from the one or more second protocol layers of the RAT protocol stack includes requesting (e.g., subscribing by the SDAC 502-a) the data, measurement, and/or analytics information from an ADRF 506-a of the WTRU 102.

In certain representative embodiments, the collecting the data, measurement, and/or analytics information from the one or more second protocol layers of the RAT protocol stack includes obtaining (e.g., by the SDAC 502-a) the data, measurement, and/or analytics information from an ADRF 506-a of the WTRU 102.

In certain representative embodiments, the collecting the data, measurement, and/or analytics information from the one or more second protocol layers of the RAT protocol stack includes obtaining (e.g., by the SDAC 502-a) the data, measurement, and/or analytics information from the one or more second protocol layers of the RAT protocol stack.

In certain representative embodiments, the RAT protocol stack may be a cellular protocol stack 510. In other representative embodiments, the RAT protocol stack may be a wireless local area network protocol stack 508.

In certain representative embodiments, the first protocol layer may be any of a radio resource control (RRC) layer, a packet data convergence protocol (PDCP) layer, a radio link control (RLC) layer, a medium access control (MAC) layer, and/or a physical (PHY) layer.

In certain representative embodiments, the first protocol layer is different than the one or more second protocol layers. As an example, the first protocol layer may be the PDCP layer and the second protocol layers may be RLC and PHY layers. As another example, the first protocol layer may be the MAC layer and the second protocol layers may be the PHY layer and the RRC layer.

In certain representative embodiments, the WTRU 102 (e.g., the SDAC 502-a) may store the collected data, measurement, and/or analytics information with an ADRF 506. For example, the ADRF may be the ADRF 506-a or 506-b as in any of FIG. 5-7, 11 or 12.

In certain representative embodiments, the providing by the WTRU 102 of the data, measurement, and/or analytics information associated with the first request at 1306 may include the WTRU 102 (e.g., SDAC 502-a) providing an indication to the first protocol layer that the collected data, measurement, and/or analytics information is stored with an ADRF 506 (e.g., ADRF 506-a, 506-b, 506-c).

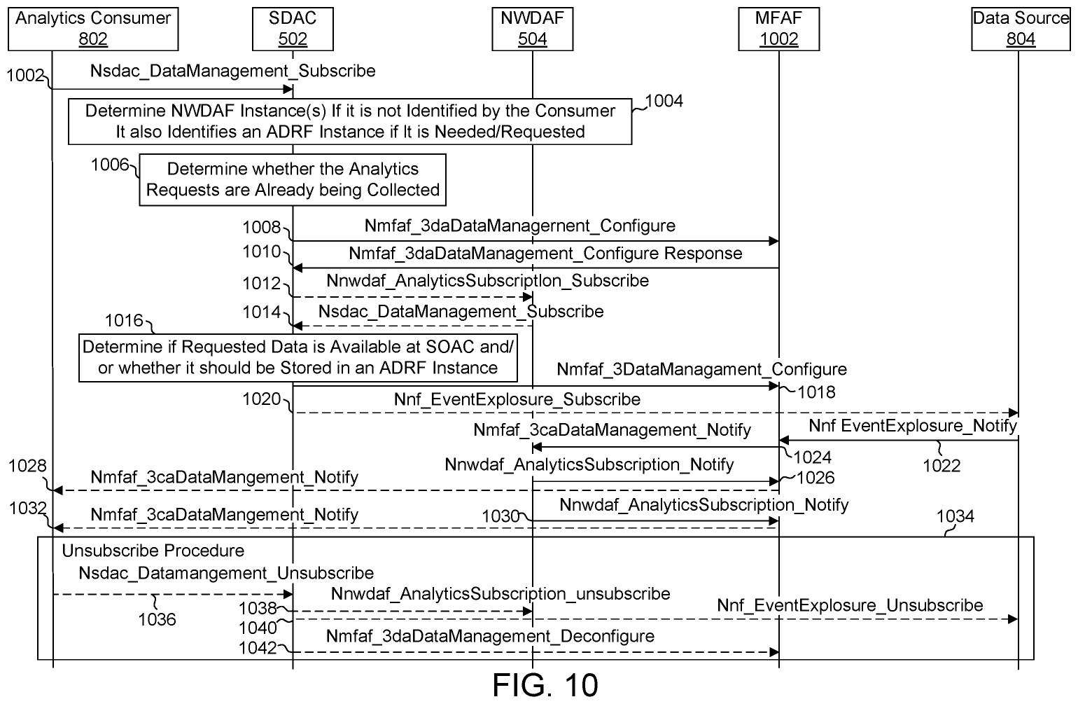

FIG. 14 is a procedural diagram illustrating an example for coordinating provisioning of information between protocol layers of different protocol stacks 508, 510. For example, the procedure of FIG. 14 may be implemented as a method by a WTRU 102 (e.g., which executes a SDAC 502-a). At 1402, the WTRU 102 (e.g., the SDAC 502-a) may receive, from a first protocol layer (e.g., RRC) of a first RAT protocol stack (e.g., 510), a first request for data, measurement, and/or analytics information associated with one or more second protocol layers (e.g., MAC, PHY, and/or LLC) of a second RAT protocol stack (e.g., 508) of the WTRU 102. In some representative embodiments, the first request may be followed by a subscribe message and/or subscription procedure as described herein. At 1404, the WTRU 102 (e.g., the SDAC 502-a) may collect the data, measurement, and/or analytics information from the one or more second protocol layers of the RAT protocol stack. For example, the WTRU 102 (e.g., the SDAC 502-a) may collect the requested information using any of the deployment scenarios described herein. At 1406, the WTRU 102 (e.g., the SDAC 502-a) may provide, to the first protocol layer, the data, measurement, and/or analytics information associated with the first request.

In certain representative embodiments, the collecting of the data, measurement, and/or analytics information from the one or more second protocol layers of the second RAT protocol stack (e.g., 508) includes requesting (e.g., subscribing by the SDAC 502-a) the data, measurement, and/or analytics information from a NWDAF 504-a of the WTRU 102.

In certain representative embodiments, the collecting of the data, measurement, and/or analytics information from the one or more second protocol layers of the second RAT protocol stack includes obtaining (e.g., by the SDAC 502-a) the data, measurement, and/or analytics information from a NWDAF 504-a of the WTRU 102.

In certain representative embodiments, the collecting the data, measurement, and/or analytics information from the one or more second protocol layers of the second RAT protocol stack includes requesting (e.g., subscribing by the SDAC 502-a) the data, measurement, and/or analytics information from an ADRF 506-a of the WTRU 102.

In certain representative embodiments, the collecting the data, measurement, and/or analytics information from the one or more second protocol layers of the second RAT protocol stack includes obtaining (e.g., by the SDAC 502-a) the data, measurement, and/or analytics information from an ADRF 506-a of the WTRU 102.

In certain representative embodiments, the collecting the data, measurement, and/or analytics information from the one or more second protocol layers of the second RAT protocol stack includes obtaining (e.g., by the SDAC 502-a) the data, measurement, and/or analytics information from the one or more second protocol layers of the second RAT protocol stack.

In certain representative embodiments, the first RAT protocol stack may be a cellular protocol stack 510. In other representative embodiments, the first RAT protocol stack may be a wireless local area network protocol stack 508.

In certain representative embodiments, the first protocol layer may be any of a radio resource control (RRC) layer, a service data application protocol (SDAP) layer, a packet data convergence protocol (PDCP) layer, a radio link control (RLC) layer, a medium access control (MAC) layer, and/or a physical (PHY) layer.

In certain representative embodiments, the first protocol layer is different than the one or more second protocol layers. As an example, the first protocol layer may be the RRC layer and the second protocol layers may be LLC and PHY layers.

In certain representative embodiments, the WTRU 102 (e.g., the SDAC 502-a) may store the collected data, measurement, and/or analytics information with an ADRF 506. For example, the ADRF may be the ADRF 506-a or 506-b as in any of FIG. 5-7, 11 or 12.

In certain representative embodiments, the providing by the WTRU 102 of the data, measurement, and/or analytics information associated with the first request at 1306 may include the WTRU 102 (e.g., SDAC 502-a) providing an indication to the first protocol layer that the collected data, measurement, and/or analytics information is stored with an ADRF 506 (e.g., ADRF 506-a, 506-b, 506-c).

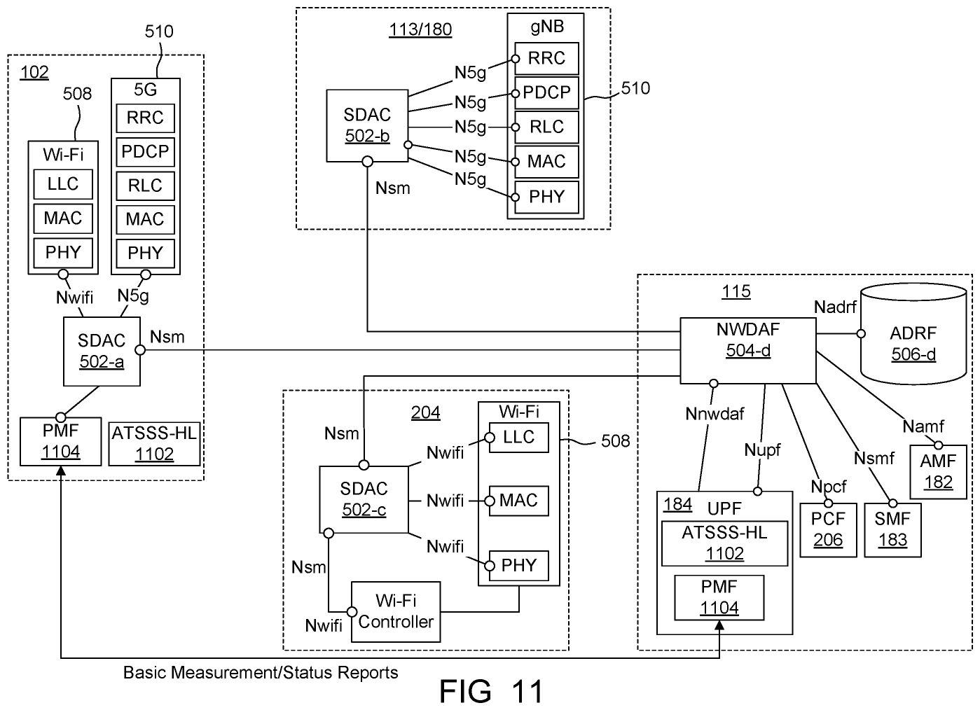

FIG. 15 is a procedural diagram illustrating an example for coordinating provisioning of information between protocol layers at different locations (e.g., a WTRU 102 and a gNB 180). For example, the procedure of FIG. 15 may be implemented as a method by a WTRU 102 (e.g., which executes a SDAC 502-a). At 1502, the WTRU 102 (e.g., the SDAC 502-a) may receive from a first protocol layer of a RAT protocol stack (e.g., 510) of the WTRU 102, a first request for data, measurement, and/or analytics information associated with one or more second protocol layers of a RAT protocol stack (e.g., 510) of a base station (e.g., gNB 180). In some representative embodiments, the first request may be followed by a subscribe message and/or subscription procedure as described herein. At 1504, the WTRU 102 (e.g., SDAC 502-a) may collect the data, measurement, and/or analytics information from the one or more second protocol layers of the RAT protocol stack (e.g., 510) of the base station. At 1506, the WTRU 102 may receive (e.g., via one or more transmissions), from the base station, the data, measurement, and/or analytics information associated with the first request. At 1508, the WTRU 102 may provide, to the first protocol layer, the data, measurement, and/or analytics information associated with the first request.

In certain representative embodiments, the collecting the data, measurement, and/or analytics information from the one or more second protocol layers of the RAT protocol stack of the base station may include the WTRU 102 (e.g., the SDAC 502-a) requesting the data, measurement, and/or analytics information from a NWDAF 504-b of the base station.

In certain representative embodiments, the collecting the data, measurement, and/or analytics information from the one or more second protocol layers of the RAT protocol stack of the base station may include the WTRU 102 (e.g., the SDAC 502-a) obtaining the data, measurement, and/or analytics information from a NWDAF 504-b of the base station.

In certain representative embodiments, the collecting the data, measurement, and/or analytics information from the one or more second protocol layers of the RAT protocol stack of the base station may include the WTRU 102 (e.g., the SDAC 502-a) requesting the data, measurement, and/or analytics information from an ADRF 506-c of the base station.

In certain representative embodiments, the collecting the data, measurement, and/or analytics information from the one or more second protocol layers of the RAT protocol stack of the base station may include the WTRU 102 (e.g., the SDAC 502-a) obtaining the data, measurement, and/or analytics information from an ADRF 506-c of the base station.

In certain representative embodiments, the collecting the data, measurement, and/or analytics information from the one or more second protocol layers of the RAT protocol stack of the base station may include the WTRU 102 (e.g., the SDAC 502-a) obtaining the data, measurement, and/or analytics information from the base station (e.g., the SDAC 502-b).

In certain representative embodiments, the RAT protocol stack may be a cellular protocol stack 510.

In certain representative embodiments, the first protocol layer may be any of a radio resource control (RRC) layer, a service data application protocol (SDAP) layer, a packet data convergence protocol (PDCP) layer, a radio link control (RLC) layer, a medium access control (MAC) layer, and/or a physical (PHY) layer. In certain representative embodiments, the first protocol layer is different than the one or more second protocol layers.

In certain representative embodiments, the WTRU 102 (e.g., the SDAC 502-a) may store the collected data, measurement, and/or analytics information with an ADRF 506 (e.g., 506-a).

In certain representative embodiments, the providing, to the first protocol layer of the RAT protocol stack, the data, measurement, and/or analytics information associated with the first request may include the WTRU 102 (e.g., the SDAC 502-a) providing an indication (e.g., a notification message) to the first protocol layer that the collected data, measurement, and/or analytics information is stored with an ADRF 506.

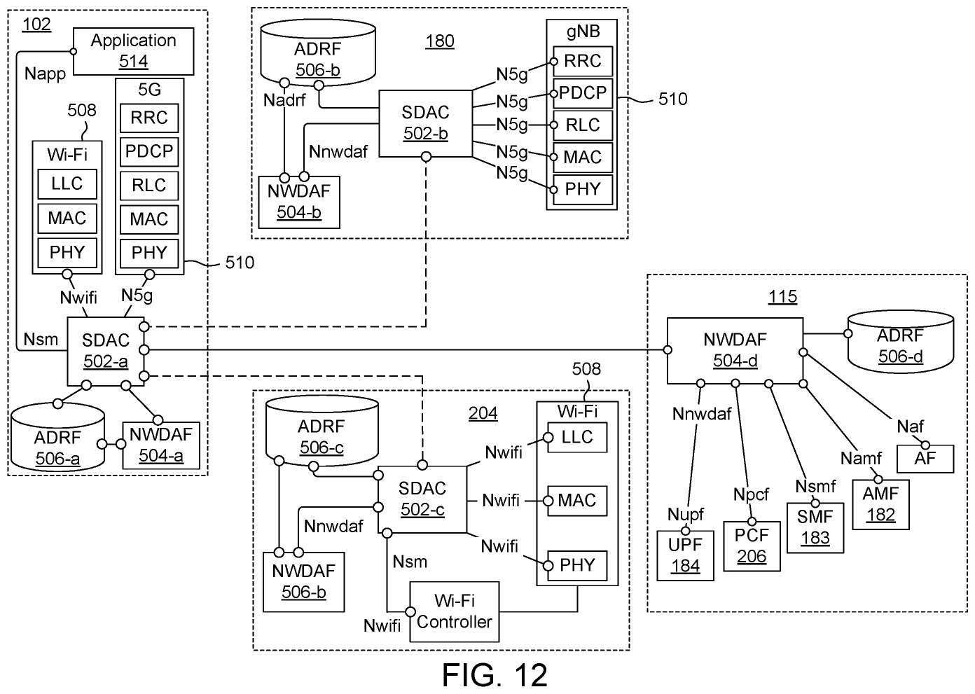

FIG. 16 is a procedural diagram illustrating another example for coordinating provisioning of information between protocol layers. For example, the procedure of FIG. 16 may be implemented as a method by a base station (BS) (e.g., gNB 180) (e.g., which executes a SDAC 502-b). At 1602 in FIG. 16, the BS (e.g., SDAC 502-b) may receive, from a first protocol layer of a RAT protocol stack (e.g., 510) of the BS, a first request for data, measurement, and/or analytics information associated with one or more second protocol layers of the RAT protocol stack of the BS. In some representative embodiments, the first request may be followed by a subscribe message and/or subscription procedure as described herein. At 1604, the BS (e.g., SDAC 502-b) may collect the data, measurement, and/or analytics information from the one or more second protocol layers of the RAT protocol stack (e., 510). At 1606, the BS (e.g., SDAC 502-b) may provide, to the first protocol layer of the RAT protocol stack (e.g., 510), the data, measurement, and/or analytics information associated with the first request.

In certain representative embodiments, the collecting of the data, measurement, and/or analytics information from the one or more second protocol layers of the RAT protocol stack may include the BS (e.g., SDAC 502-b) requesting the data, measurement, and/or analytics information from a NWDAF 504-b of the BS.

In certain representative embodiments, the collecting of the data, measurement, and/or analytics information from the one or more second protocol layers of the RAT protocol stack may include the BS (e.g., SDAC 502-b) obtaining the data, measurement, and/or analytics information from a NWDAF 504-b of the BS.

In certain representative embodiments, the collecting of the data, measurement, and/or analytics information from the one or more second protocol layers of the RAT protocol stack may include the BS (e.g., SDAC 502-b) requesting the data, measurement, and/or analytics information from an ADRF 506-b of the BS.

In certain representative embodiments, the collecting of the data, measurement, and/or analytics information from the one or more second protocol layers of the RAT protocol stack may include the BS (e.g., SDAC 502-b) obtaining the data, measurement, and/or analytics information from an ADRF 506 (e.g., ADRF 506-b of the BS).

In certain representative embodiments, the collecting of the data, measurement, and/or analytics information from the one or more second protocol layers of the RAT protocol stack may include the BS (e.g., SDAC 502-b) obtaining the data, measurement, and/or analytics information from the one or more second protocol layers of the RAT protocol stack.

In certain representative embodiments, the RAT protocol stack may be a cellular protocol stack 510.

In certain representative embodiments, the first protocol layer may be any of a radio resource control (RRC) layer, a service data application protocol (SDAP) layer, a packet data convergence protocol (PDCP) layer, a radio link control (RLC) layer, a medium access control (MAC) layer, and/or a physical (PHY) layer. In certain representative embodiments, the first protocol layer is different than the one or more second protocol layers.

In certain representative embodiments, the BS (e.g., the SDAC 502-b) may store the collected data, measurement, and/or analytics information with an ADRF 506, such as the ADRF 506-b of the BS.

In certain representative embodiments, the providing of the data, measurement, and/or analytics information associated with the first request includes the BS (e.g., SDAC 502-b) providing an indication (e.g., notification message) to the first protocol layer that the collected data, measurement, and/or analytics information is stored with an ADRF 506.

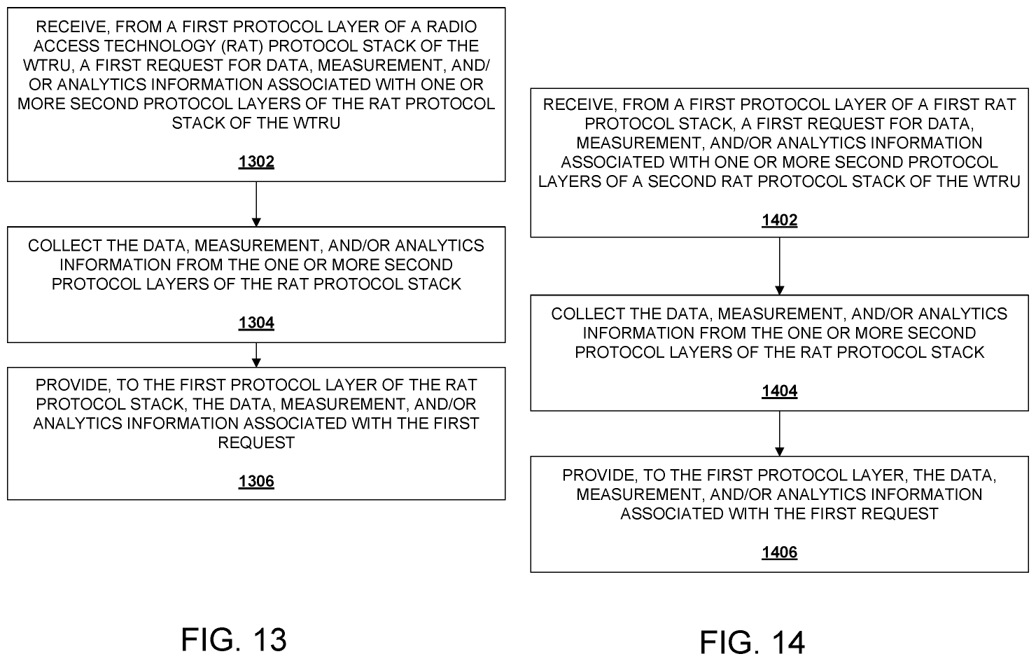

FIG. 17 is a procedural diagram illustrating an example for coordinating provisioning of information between protocol layers at different locations. For example, the procedure of FIG. 17 may be implemented as a method by a BS (e.g., which executes a SDAC 502-b). At 1702, the BS (e.g., SDAC 502-b) may receive, from a first protocol layer of a RAT protocol stack (e.g., 510) of the BS, a first request for data, measurement, and/or analytics information associated with one or more second protocol layers of the RAT protocol stack of the BS. At 1704, the BS (e.g., SDAC 502-b) may receive, from the first protocol layer of the RAT protocol stack of the BS, a second request for data, measurement, and/or analytics information associated with one or more network functions of a CN 115. At 1706, the BS (e.g., SDAC 502-b) may collect the data, measurement, and/or analytics information from the one or more second protocol layers of the RAT protocol stack. At 1708, the BS (e.g., SDAC 502-b) may collect the data, measurement, and/or analytics information associated with the one or more network functions (e.g., from a NWDAF 504-d). At 1710, the BS (e.g., SDAC 502-b) may provide, to the first protocol layer of the RAT protocol stack, the data, measurement, and/or analytics information associated with the first request and/or the second request.

In certain representative embodiments, the collecting of the data, measurement, and/or analytics information from the one or more second protocol layers of the RAT protocol stack may include the BS (e.g., SDAC 502-b) may requesting the data, measurement, and/or analytics information from a NWDAF 504-b.

In certain representative embodiments, the collecting the data, measurement, and/or analytics information from the one or more second protocol layers of the RAT protocol stack may include the BS (e.g., SDAC 502-b) obtaining the data, measurement, and/or analytics information from a NWDAF 504-b.

In certain representative embodiments, the collecting of the data, measurement, and/or analytics information from the one or more second protocol layers of the RAT protocol stack may include the BS (e.g., SDAC 502-b) requesting the data, measurement, and/or analytics information from an ADRF 506-b and/or 506-d.

In certain representative embodiments, the collecting of the data, measurement, and/or analytics information from the one or more second protocol layers of the RAT protocol stack may include the BS (e.g., SDAC 502-b) obtaining the data, measurement, and/or analytics information from an ADRF 506-b and/or 506-d.

In certain representative embodiments, the collecting of the data, measurement, and/or analytics information from the one or more network functions may include the BS (e.g., SDAC 502-b) requesting the data, measurement, and/or analytics information from a NWDAF 504-b and/or 504-d.

In certain representative embodiments, the collecting of the data, measurement, and/or analytics information from the one or more network functions may include the BS (e.g., SDAC 502-b) obtaining the data, measurement, and/or analytics information from a NWDAF 504-b and/or 504-d.

In certain representative embodiments, the collecting of the data, measurement, and/or analytics information from the one or more network functions may include the BS (e.g., SDAC 502-b) requesting the data, measurement, and/or analytics information from an ADRF 506-b and/or 506-d.

In certain representative embodiments, the collecting of the data, measurement, and/or analytics information from the one or more network functions may include the BS (e.g., SDAC 502-b) obtaining the data, measurement, and/or analytics information from an ADRF 506-b and/or 506-d.

In certain representative embodiments, the collecting of the data, measurement, and/or analytics information from the one or more second protocol layers of the RAT protocol stack may include the BS (e.g., SDAC 502-b) obtaining the data, measurement, and/or analytics information from the one or more second protocol layers of the RAT protocol stack.

In certain representative embodiments, the collecting of the data, measurement, and/or analytics information from the one or more network functions may include the BS (e.g., SDAC 502-b) obtaining the data, measurement, and/or analytics information from the one or more network functions.

In certain representative embodiments, the RAT protocol stack is a cellular protocol stack 510.

In certain representative embodiments, the first protocol layer may be any of a radio resource control (RRC) layer, a service data application protocol (SDAP) layer, a packet data convergence protocol (PDCP) layer, a radio link control (RLC) layer, a medium access control (MAC) layer, and/or a physical (PHY) layer. In certain representative embodiments, the first protocol layer is different than the one or more second protocol layers.

In certain representative embodiments, the BS (e.g., SDAC 502-b) may store the collected data, measurement, and/or analytics information with an ADRF 506-b and/or 506-d.

In certain representative embodiments, the providing, to the first protocol layer of the RAT protocol stack, of the data, measurement, and/or analytics information associated with the first request may include the BS (e.g., SDAC 502-b) providing an indication (e.g., notification message) to the first protocol layer that the collected data, measurement, and/or analytics information is stored with an ADRF 506-b.

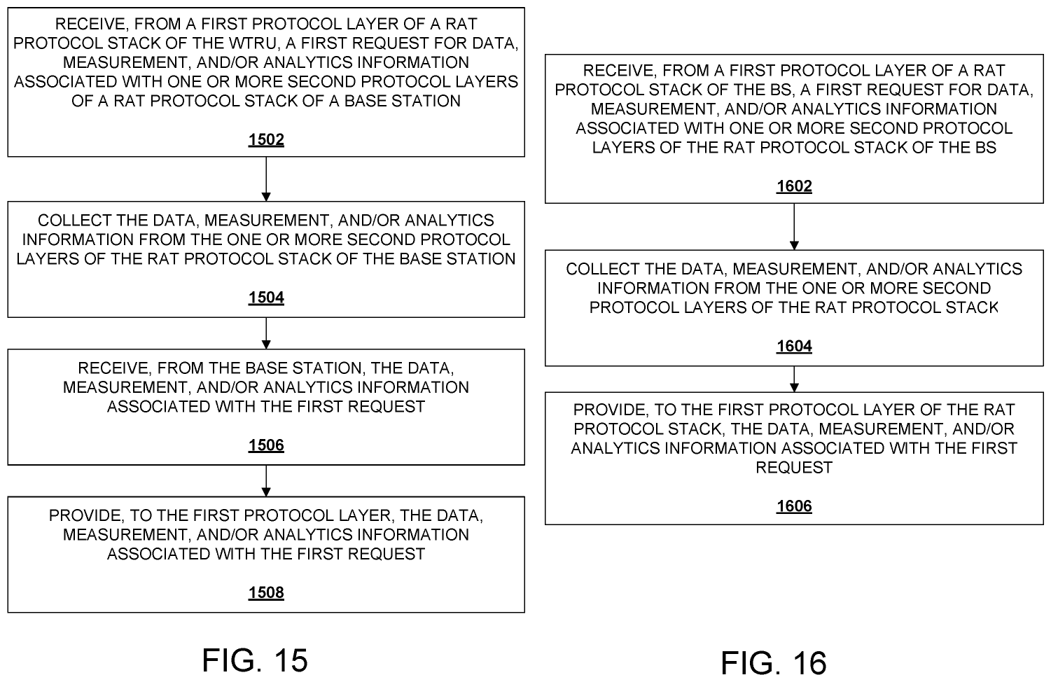

FIG. 18 is a procedural diagram illustrating another example for coordinating provisioning of information between protocol layers. For example, the procedure of FIG. 18 may be implemented as a method by a WTRU 102 (e.g., which executes a SDAC 502-a). At 1802, the WTRU 102 (e.g., the SDAC 502-a) may receive, from a first protocol layer of a radio access technology (RAT) protocol stack (e.g., 510) of the WTRU 102, a first request for data, measurement, and/or analytics information associated with one or more second protocol layers of the RAT protocol stack (e.g., 510) of the BS (e.g., gNB). At 1804, the WTRU 102 (e.g., the SDAC 502-a) may receive, from the first protocol layer of the RAT protocol stack of the WTRU, a second request for data, measurement, and/or analytics information associated with one or more network functions of a CN 115 for the WTRU 102. At 1806, the WTRU 102 (e.g., the SDAC 502-a) may collect the data, measurement, and/or analytics information from the one or more second protocol layers of the RAT protocol stack (e.g., via a NWDAF 504-b and/or an ADRF 506-b). At 1808, the WTRU 102 (e.g., the SDAC 502-a) may collect the data, measurement, and/or analytics information from the one or more network functions (e.g., via a NWDAF 504-d and/or an ADRF 506-d). At 1810, the WTRU 102 (e.g., the SDAC 502-a) may provide, to the first protocol layer of the RAT protocol stack, the data, measurement, and/or analytics information associated with the first request and/or the second request.

In certain representative embodiments, the collecting of the data, measurement, and/or analytics information from the one or more second protocol layers of the RAT protocol stack may include the WTRU 102 (e.g., the SDAC 502-a) requesting (e.g., subscribing to) the data, measurement, and/or analytics information from a NWDAF 504-a.

In certain representative embodiments, the collecting the data, measurement, and/or analytics information from the one or more second protocol layers of the RAT protocol stack may include the WTRU 102 (e.g., the SDAC 502-a) obtaining the data, measurement, and/or analytics information from a NWDAF 504-a.

In certain representative embodiments, the collecting of the data, measurement, and/or analytics information from the one or more second protocol layers of the RAT protocol stack may include the WTRU 102 (e.g., the SDAC 502-a) requesting (e.g., subscribing to) the data, measurement, and/or analytics information from an ADRF 506-a and/or 506-b.

In certain representative embodiments, the collecting of the data, measurement, and/or analytics information from the one or more second protocol layers of the RAT protocol stack may include the WTRU 102 (e.g., the SDAC 502-a) obtaining the data, measurement, and/or analytics information from an ADRF 506-a and/or 506-b.

In certain representative embodiments, the collecting of the data, measurement, and/or analytics information from the one or more network functions may include the WTRU 102 (e.g., the SDAC 502-a) requesting (e.g., subscribing to) the data, measurement, and/or analytics information from a NWDAF 504-a and/or 504-d.

In certain representative embodiments, the collecting of the data, measurement, and/or analytics information from the one or more network functions may include the WTRU 102 (e.g., the SDAC 502-a) obtaining the data, measurement, and/or analytics information from a NWDAF 504-a and/or 504-d.

In certain representative embodiments, the collecting of the data, measurement, and/or analytics information from the one or more network functions may include the WTRU 102 (e.g., the SDAC 502-a) requesting (e.g., subscribing to) the data, measurement, and/or analytics information from an ADRF 506-a and/or 506-d.

In certain representative embodiments, the collecting of the data, measurement, and/or analytics information from the one or more network functions may include the WTRU 102 (e.g., the SDAC 502-a) obtaining the data, measurement, and/or analytics information from an ADRF 506-a and/or 506-d.

In certain representative embodiments, the collecting of the data, measurement, and/or analytics information from the one or more second protocol layers of the RAT protocol stack may include the WTRU 102 (e.g., the SDAC 502-a) obtaining the data, measurement, and/or analytics information from the one or more second protocol layers of the RAT protocol stack (e.g., via a SDAC 502-b).

In certain representative embodiments, the collecting of the data, measurement, and/or analytics information from the one or more network functions may include the WTRU 102 (e.g., the SDAC 502-a) obtaining the data, measurement, and/or analytics information from the one or more network functions.

In certain representative embodiments, the RAT protocol stack may be a cellular protocol stack 510.

In certain representative embodiments, the first protocol layer may be any of a radio resource control (RRC) layer, a packet data convergence protocol (PDCP) layer, a radio link control (RLC) layer, a medium access control (MAC) layer, and/or a physical (PHY) layer. In certain representative embodiments, the first protocol layer is different than the one or more second protocol layers.

In certain representative embodiments, the WTRU 102 (e.g., the SDAC 502-a) may store the collected data, measurement, and/or analytics information with an ADRF 506-a and/or 506-d.

In certain representative embodiments, the providing, to the first protocol layer of the RAT protocol stack, of the data, measurement, and/or analytics information associated with the first request may include the WTRU 102 (e.g., the SDAC 502-a) providing an indication (e.g., notification message) to the first protocol layer that the collected data, measurement, and/or analytics information is stored with an ADRF 506-a.

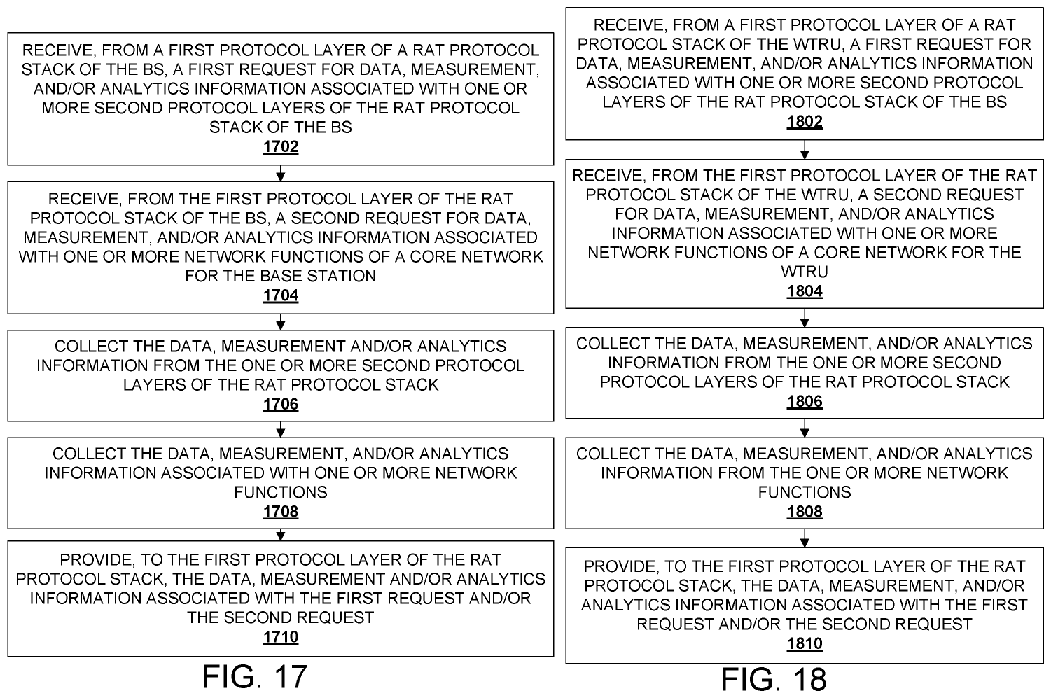

FIG. 19 is a procedural diagram illustrating an example for coordination provisioning of information between an application and protocol layers. For example, the procedure of FIG. 19 may be implemented as a method by a WTRU 102 (e.g., which executes a SDAC 502-a). At 1902, the WTRU 102 (e.g., the SDAC 502-a) may receive, from an application 514 executed by the WTRU 102, a first request for data, measurement, and/or analytics information associated with one or more protocol layers of a RAT protocol stack (e.g., 508, 510) of the WTRU 102. At 1904, the WTRU 102 (e.g., the SDAC 502-a) may collect the data, measurement, and/or analytics information from the one or more protocol layers of the RAT protocol stack. At 1906, the WTRU 102 (e.g., the SDAC 502-a) may provide, to the application 514, the data, measurement, and/or analytics information associated with the first request.

In certain representative embodiments, any of 1902, 1904, and/or 1906 may be performed as described herein with respect to other embodiments. For example, the provisioning at 1906 may be performed using any of a NWDAF 504 and/or ADRF 506 as described herein.

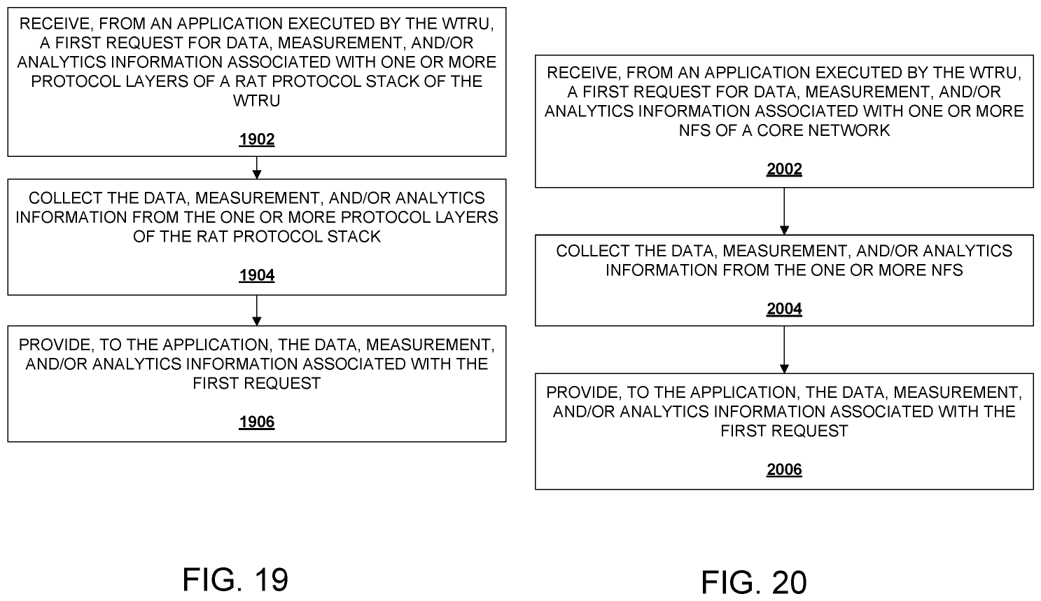

FIG. 20 is a procedural diagram illustrating an example for coordination provisioning of information between an application and protocol layers. For example, the procedure of FIG. 20 may be implemented as a method by a WTRU 102 (e.g., which executes a SDAC 502-a). At 2002, the WTRU 102 (e.g., the SDAC 502-a) may receive, from an application 514 executed by the WTRU 102, a first request for data, measurement, and/or analytics information associated with one or more NFs of a CN 115 for the WTRU 102. At 2004, the WTRU 102 (e.g., the SDAC 502-a) may collect the data, measurement, and/or analytics information from the one or more network functions of the CN 115. At 2006, the WTRU 102 (e.g., the SDAC 502-a) may provide, to the application 514, the data, measurement, and/or analytics information associated with the first request.

In certain representative embodiments, any of 2002, 2004, and/or 2006 may be performed as described herein with respect to other embodiments. For example, the provisioning at 1906 may be performed using any of a NWDAF 504 and/or ADRF 506 as described herein.

In certain representative embodiments, any of the procedural diagrams of FIGS. 13-20 may be combined and/or modified as described herein. For example, a (e.g., first) request in any of FIGS. 13-20 may serve as a second request in any other of FIGS. 13-20. For example, a WTRU 102 (e.g., SDAC 502-a) may coordinate the exchange of data, measurement, and/or analytics information between protocol layers of the WTRU 102 while also coordination the exchange of data, measurement, and/or analytics information between an application 514 and network functions of the CN 115. A BS (e.g., gNB 180 and/or Wi-Fi AP 204) may perform similar combinations of exchange of data, measurement, and/or analytics information as the WTRU 102, such as shown in FIGS. 5-7 and 11-12, for example.

In certain representative embodiments, one or more procedures described herein may be implemented by a WTRU 102 as a method. For example, a WTRU 102 may send, using a first radio access technology (RAT) or a second RAT, a first subscription request message to a first network entity. The first subscription request message may be associated with data, measurement, and/or analytics information related to any of a first data source (e.g., protocol stack layer of a network entity) and/or a second data source (e.g., another protocol stack layer). The WTRU 102 may receive, using the first RAT or the second RAT, a response message including the data, measurement, and/or analytics information from the first network entity or a second subscription request message associated with the measurement and/or analytics information. The WTRU 102 may, on condition that the second subscription request message is received, send a third subscription request message associated with the data, measurement, and/or analytics information to any of the first data source using the first RAT and/or the second data source using the second RAT. The WTRU 102 may receive one or more notification messages from any of the first data source using the first RAT and/or the second data source using the second RAT. Any (e.g., each) of the one or more notification messages may include at least a portion of the measurement and/or analytics information.

In certain representative embodiments, one or more procedures described herein may be implemented by a network entity as a method. The network entity may be a base station (e.g., gNB 180, Wi-Fi AP) of an access network. For example, a base station may send a first subscription request message to a first network entity. The first subscription request message may be associated with data, measurement, and/or analytics information related to any of a first data source (e.g., protocol stack layer of a network entity) and/or a second data source (e.g., another protocol stack layer of a network entity or WTRU 102). The base station may receive, from the first network entity, a response message including the data, measurement, and/or analytics information from the first network entity or a second subscription request message associated with the measurement and/or analytics information. The base station may, on condition that the second subscription request message is received, send a third subscription request message associated with the data, measurement, and/or analytics information to any of the first data source using a first radio access technology (RAT) and/or the second data source which is associated with a second RA. The base station may receive one or more notification messages from any of the first data source using the first RAT and/or the second data source. Any (e.g., each) of the one or more notification messages including at least a portion of the measurement and/or analytics information.

For example, after receiving the one or more notification messages, the data, measurement, and/or analytics information received in the one or more notification messages may be sent to the first network entity. The first network entity may have computer resources which are configured to execute a network data analytics function (NWDAF) and/or an analytics data repository function (ADRF).

For example, the measurement and/or analytics information, received from the first data source, may be associated with at least one layer of a protocol stack of the first data source. The data, measurement, and/or analytics information may be associated with the protocol stack for the first RAT.

For example, the measurement and/or analytics information, received from the first data source, may be associated with at least one layer of a protocol stack of the second data source. The data, measurement, and/or analytics information may be associated with the protocol stack for the second RAT.

For example, an unsubscribe request message associated with the data, measurement, and/or analytics information may be sent to any of the first network entity, the first data source and/or the second data source.

For example, the first data source may be a radio access network (RAN) entity associated with the first RAT.

For example, the first data source may be a Wi-Fi entity associated with the first RAT.

For example, the first data source may be a network entity executing a core network function.

For example, the second data source may be a WTRU 102.

In certain representative embodiments, one or more procedures described herein may be implemented by a WTRU 102 as a method. For example, a WTRU 102 may receive, from a first base station using a first RAT, a first subscription request message. The first subscription request message may be associated with data, measurement, and/or analytics information related to (e.g., from a layer of a protocol stack of) the WTRU 102. The WTRU 102 may, on condition that the first subscription request message is received, send one or more notification messages associated with the first subscription message to the first base station using the first RAT. Any (e.g., each) of the one or more notification messages may include at least a portion of the measurement and/or analytics information.

For example, the WTRU 102 may receive, from a second base station using a second RAT, a second subscription request message. The second subscription request message may be associated with data, measurement, and/or analytics information related to (e.g., from a layer of a protocol stack of) the WTRU 102. The WTRU 102 may, on condition that the second subscription request message is received, send one or more notification messages associated with the second subscription message to the second base station using the second RAT. Any (e.g., each) of the one or more notification messages including at least a portion of the measurement and/or analytics information.

In certain representative embodiments, one or more procedures described herein may be implemented by a network entity as a method. The network entity may be a base station (e.g., gNB 180, Wi-Fi AP) of an access network. For example, a first base station may receive, from a second base station of another access network which uses a second RAT, a first subscription request message. The first subscription request message may be associated with data, measurement, and/or analytics information related to (e.g., from a layer of the protocol stack of) the first base station. The first base station may, on condition that the first subscription request message is received, send one or more notification messages associated with the first subscription message to the second base station. Any (e.g., each) of the one or more notification messages may include at least a portion of the measurement and/or analytics information.

For example, the first base station may receive, from a WTRU 102 using the first RAT, a second subscription request message. The second subscription request message may be associated with data, measurement, and/or analytics information related to (e.g., from a layer of the protocol stack of) the first base station. The first base station may, on condition that the second subscription request message is received, send one or more notification messages associated with the second subscription message to the WTRU 102 using the first RAT. Any (e.g., each) of the one or more notification messages may include at least a portion of the measurement and/or analytics information.

In certain representative embodiments, one or more procedures described herein may be implemented by a network entity as a method. The network entity may be provided in an access network. The network entity may have computer resources configured to execute an ADRF. For example, a first network entity may receive, from a first base station associated with a first RAT, a first subscription request message associated with data, measurement, and/or analytics information (e.g., from a layer of a protocol stack). The first network entity may, on condition that the network entity stores (e.g., has stored) the measurement and/or analytics information, send one or more messages to the base station. Any (e.g., each) of the one or more messages including at least a portion of the measurement and/or analytics information. The first network entity may, on condition that the first network entity does not (e.g., currently) store the measurement and/or analytics information, send a second subscription request message associated with data, measurement, and/or analytics information to any of the first base station and/or a second network entity. The first network entity may, after sending the second subscription request message, receive one or more messages from the first base station. Any (e.g., each) of the one or more messages may include the measurement and/or analytics information.

For example, the data, measurement, and/or analytics information may be associated with (e.g., a layer of a protocol stack of) any of a WTRU 102 using the first RAT, a second base station associated with a second RAT, and/or the WTRU 102 using the second RAT.

For example, the data, measurement, and/or analytics information may be associated with (e.g., generated, derived, and/or aggregated from) at least one layer of a protocol stack of any of the WTRU 102 and/or the second base station.

For example, the WTRU 102 and/or the base station may have a processor and transceiver which are configured to perform any of the procedures, including modifications and combinations thereof, as described herein. For example, a non-transitory, computer-readable storage medium may have instructions that, when executed by a processor, cause the processor to perform any of the procedures, including modifications and combinations thereof, as described herein.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
receiving, from a first protocol layer of a radio access technology (RAT) protocol stack of the WTRU, a first request for data, measurement and/or analytics information associated with one or more second protocol layers of the RAT protocol stack of the WTRU;
collecting the data, measurement and/or analytics information from the one or more second protocol layers of the RAT protocol stack; and
providing, to the first protocol layer of the RAT protocol stack, the data, measurement and/or analytics information associated with the first request.

2. The method of claim 1, wherein the collecting the data, measurement and/or analytics information from the one or more second protocol layers of the RAT protocol stack includes: requesting the data, measurement and/or analytics information from a network data analytics function (NWDAF) entity of the WTRU, and obtaining the data, measurement and/or analytics information from the NWDAF entity of the WTRU.

3. (canceled)

4. The method of claim 1, wherein the collecting the data, measurement and/or analytics information from the one or more second protocol layers of the RAT protocol stack includes requesting the data, measurement and/or analytics information from an analytics data repository function (ADRF) entity of the WTRU, and obtaining the measurement and/or analytics information from the ADRF of the WTRU.

5. (canceled)

6. The method of claim 1, wherein the collecting the data, measurement and/or analytics information from the one or more second protocol layers of the RAT protocol stack includes obtaining the data, measurement and/or analytics information from the one or more second protocol layers of the RAT protocol stack.

7. The method of claim 1, wherein the RAT protocol stack is a cellular protocol stack which includes a radio resource control (RRC) layer, a service data protocol, a service data application protocol (SDAP) layer, a packet data convergence protocol (PDCP) layer, a radio link control (RLC) layer, a medium access control (MAC) layer, and/or a physical (PHY) layer, and
wherein the first protocol layer is different than the one or more second protocol layers.

8.-9. (canceled)

10. The method of claim 1, further comprising:
storing the collected data, measurement and/or analytics information with an analytics data repository function (ADRF) entity.

11. The method of claim 1, wherein the providing, to the first protocol layer of the RAT protocol stack, the data, measurement and/or analytics information associated with the first request includes providing an indication to the first protocol layer that the collected data, measurement and/or analytics information is stored with an analytics data repository function (ADRF) entity.

12. A wireless transmit/receive unit (WTRU) comprising:
a processor, a transceiver, and a memory which are configured to:
receive, from a first protocol layer of a radio access technology (RAT) protocol stack of the WTRU, a first request for data, measurement and/or analytics information associated with one or more second protocol layers of the RAT protocol stack of the WTRU,
collect the data, measurement and/or analytics information from the one or more second protocol layers of the RAT protocol stack, and
provide, to the first protocol layer of the RAT protocol stack, the data, measurement and/or analytics information associated with the first request.

13. The WTRU of claim 12, wherein the processor, the transceiver, and the memory are configured to collect the data, measurement and/or analytics information from the one or more second protocol layers of the RAT protocol stack which includes to request the data, measurement and/or analytics information from a network data analytics function (NWDAF) entity of the WTRU, and obtain the measurement and/or analytics information from the NWDAF entity of the WTRU.

14. (canceled)

15. The WTRU of claim 12, wherein the processor, the transceiver, and the memory are configured to collect the data, measurement and/or analytics information from the one or more second protocol layers of the RAT protocol stack which includes to request the measurement and/or analytics information from an analytics data repository function (ADRF) entity of the WTRU, and obtain the measurement and/or analytics information from the ADRF of the WTRU.

16. (canceled)

17. The WTRU of claim 12, wherein the processor, the transceiver, and the memory are configured to collect the data, measurement and/or analytics information from the one or more second protocol layers of the RAT protocol stack which includes to obtain the data, measurement and/or analytics information from the one or more second protocol layers of the RAT protocol stack.

18. The WTRU of claim 12, wherein the RAT protocol stack is a cellular protocol stack which includes a radio resource control (RRC) layer, a service data protocol, a service data application protocol (SDAP) layer, a packet data convergence protocol (PDCP) layer, a radio link control (RLC) layer, a medium access control (MAC) layer, and/or a physical (PHY) layer, and
wherein the first protocol layer is different than the one or more second protocol layers.

19.-20. (canceled)

21. The WTRU of claim 12, wherein the processor, the transceiver and the memory are configured to:
store the collected data, measurement and/or analytics information with an analytics data repository function (ADRF) entity.

22. The WTRU of claim 12, wherein the processor, the transceiver and the memory are configured to provide an indication to the first protocol layer that the collected measurement and/or analytics information is stored with an analytics data repository function (ADRF) entity.
